(19) United States
(12) Patent Application Publication
(10) Pub. No.: US 2017/0059687 A1
(43) Pub. Date: Mar. 2, 2017

(54) DEVICE-LOCATION ESTIMATION BASED ON RSSI MEASUREMENTS OVER WIFI AND BLUETOOTH

(71) Applicant: Harman International Industries, Incorporated, Stamford, CT (US)

(72) Inventors: Vaibhav Dinesh, Delhi (IN); Prakash Tripathi, Gurgaon (IN); Ajit Singh, Gurgaon (IN)

(21) Appl. No.: 15/056,902

(22) Filed: Feb. 29, 2016

(30) Foreign Application Priority Data
Aug. 25, 2015 (IN) 4461/CHE/2015

(51) Int. Cl. G01S 5/02; H04W 64/00

(52) U.S. Cl. CPC G01S 5/0252; G01S 5/0263; H04W 64/003; H04W 84/12

(57) ABSTRACT

Examples of systems and methods for estimating a device location are disclosed. In one example, a device locating system includes three or more sensor devices, a processor, and a storage device storing instructions executable to determine an estimated location of a scanned device based on a received signal strength indication (RSSI) value for the scanned device measured by at least three of the three or more sensor devices and processed in view of previously-recorded RSSI values for the scanned device. The instructions are further executable to output the estimated location of the scanned device to a computing device for controlling operation of the computing device.

### CROSS REFERENCE TO RELATED APPLICATIONS

The present application claims priority to Indian Provisional Application No. 4461/CHE/2015, entitled “DEVICE-LOCATION ESTIMATION BASED ON RSSI MEASUREMENTS OVER WIFI AND BLUETOOTH,” and filed on Aug. 25, 2015, the entire contents of which are hereby incorporated by reference for all purposes.

### FIELD

The disclosure relates to measuring a received signal strength indication (RSSI) over wireless connections.

### BACKGROUND

With the advent and proliferation of machine to machine (M2M) communication and inter-networking of things (IoT), together with availability of much cheaper and smaller radio modules and micro-computers, wireless sensor networks (WSN) have found their way in a wide variety of applications ranging from military to healthcare and environment monitoring. While on one hand this serves as an advantage without bounds and at all levels, be it individual, home or organization; however, with inappropriate access the same can pose a considerable hazard to the mankind as such. Accordingly, for a variety of requirements ranging from security to numerous business prospects, the determination of the position of devices in a non-intrusive manner has been a highly desirable trait. In particular with respect to outdoor environments this aspect is duly addressed through various dedicated technologies like the Global Positioning System (GPS) as well as through proprietary methods employing the existing infrastructure of a Radio Access Network (RAN). Additionally, while some of these solutions may also be frequently employed for reporting location with the device positioned indoors, the accuracy in such scenarios is often drastically compromised.

The feasibility of locating the targeted device to within sufficient accuracy and reliability, in indoor environments, based on the received signal strength indicator (RSSI) has been a well-researched area. However while, theoretically, there are a number of radio propagation models predicting signal-strength loss with distance, these models are based on the ensemble signal statistics; in a real-life application, the presence of reflection, scattering and other physical phenomena affecting the wireless channel have an extreme impact on the measured RSSI, often terming the latter as a “bad estimator” of the transmitting device's distance from the receiving entity.

Evading the randomness in the measured RSSI and observing an inherent trend in the same closely matching with the conventional radio propagation models, together with gauging significant interest in the IoT community on the ability to trace and track position of an entity (or person) within a subjected premises, there is a strong motivation to pursue this development.

### SUMMARY

The present disclosure provides a novel, non-intrusive approach to determining the location of a BLUETOOTH and WIFI enabled device in an indoor environment. The uniqueness of the solution lies in its self-reliant ability to track the targeted device in an indoor/outdoor environment to a reasonable accuracy, without employing any of the existing positioning technologies, e.g. GPS, or having any dependency on an existing RAN (Radio Access Network) infrastructure. The solution comprises of a two-phase approach constituting the learning phase for reference generation, followed by the location-determination phase. The suitability of the reference is critical to the accuracy in estimating the targeted device's location; additionally, subject to the locale for deployment of the system, a suitable pre-determined reference could be adapted by exploiting any existing matching infrastructure, within the subject premises, for an expeditious system bring-up. The proposed solution has been extensively tested successfully in a live office environment.

Examples of systems and methods for estimating a device-location are disclosed. In one example, a device locating system includes three or more sensor devices, a processor, and a storage device storing instructions executable to determine an estimated location of a scanned device based on a received signal strength indication (RSSI) value for the scanned device measured by the three or more sensor devices (e.g., measured by at least three of the three or more sensor devices) and processed in view of previously-recorded RSSI values for the scanned device. The instructions are further executable to output the estimated location of the scanned device to a computing device for controlling operation of the computing device.

### BRIEF DESCRIPTION OF THE DRAWINGS

The disclosure may be better understood from reading the following description of non-limiting embodiments, with reference to the attached drawings, wherein below:

FIG. 1 shows an example interconnection of primary components that may form an RSSI-based distance estimation system in accordance with one or more embodiments of the present disclosure;

FIG. 2 shows example placement of three sensor devices for position determination in accordance with one or more embodiments of the present disclosure;

FIG. 3 shows an example plot of temporal variations in RSSI, at some fixed device location in accordance with one or more embodiments of the present disclosure;

FIG. 4 shows an example plot for reference curve generation, based on a piecewise linear approach in accordance with one or more embodiments of the present disclosure;

FIG. 5 shows an example plot for reference curve generation, based on theoretical path-loss model fitment in accordance with one or more embodiments of the present disclosure;

FIG. 6 shows an example plot of Expected Region-of-Presence of the test-device around each sensor in accordance with one or more embodiments of the present disclosure;

FIG. 7 shows an example plot for Point-of-Intersection (PoIs) on different circle-pairs in accordance with one or more embodiments of the present disclosure;

FIG. 8 shows an example plot for Estimated Region-of-Presence and corresponding Centroid in accordance with one or more embodiments of the present disclosure;

FIG. 9 shows an example plot for Refined Estimated Region-of-Presence and corresponding Centroid in accordance with one or more embodiments of the present disclosure;

FIG. 10 shows an example RSSI-Based-Location-Estimation System Implementation in accordance with one or more embodiments of the present disclosure;

FIG. 11 shows an example Floor-Plan of the Development-site with (Meshlium) Sensors installed in accordance with one or more embodiments of the present disclosure;

FIG. 12 shows an example plot for Location-Estimation for BLUETOOTH device: Test-Case-1 in accordance with one or more embodiments of the present disclosure;

FIG. 13 shows an example plot for Location-Estimation for BLUETOOTH device: Test-Case-2 in accordance with one or more embodiments of the present disclosure;

FIG. 14 shows an example plot for Location-Estimation for BLUETOOTH device: Test-Case-3 in accordance with one or more embodiments of the present disclosure;

FIG. 15 shows an example plot for Location-Estimation for BLUETOOTH device: Test-Case-4 in accordance with one or more embodiments of the present disclosure;

FIG. 16 shows an example plot for Location-Estimation for WIFI device: Test-Case-5 in accordance with one or more embodiments of the present disclosure;

FIG. 17 shows an example plot for Location-Estimation for WIFI device: Test-Case-6 in accordance with one or more embodiments of the present disclosure;

FIG. 18 shows an example plot for Location-Estimation for WIFI device: Test-Case-7 in accordance with one or more embodiments of the present disclosure;

FIG. 19 shows an example plot for Location-Estimation for WIFI device: Test-Case-8 in accordance with one or more embodiments of the present disclosure;

FIG. 20 is an overall flow chart of an example method for determining an estimated region of presence (E-RoP) of scanned/test devices in accordance with one or more embodiments of the present disclosure;

FIGS. 21 and 22 are flow charts of an example method for obtaining and storing reference relationship data as a learning phase of the method illustrated in FIG. 20 in accordance with one or more embodiments of the present disclosure; and

FIG. 23 is a flow chart of an example method for estimating a location of scanned/test device(s) as a location estimation phase of the method illustrated in FIG. 20 in accordance with one or more embodiments of the present disclosure.

### DETAILED DESCRIPTION

One generic use-case for location estimation as disclosed pertains to tracing and tracking of device(s)/people, alien or known, within a subject premises; in which the objectives of the same may be multi-fold, e.g.:
Security measure (e.g.: In the event of an untoward incidence, the ability to trace and track alien/anti-social elements within the premises, both from current as well as near historical perspective)
Human tracking (e.g., by associating the device with a person possessing it)
Asset management (e.g.: By maintaining history of the device's presence within the premises, a time-line representation of the particular device's location can give useful insights about its usage and whereabouts)
Tracking footfall traffic in a commercial real estate or tracking visitor-flow at an exhibition
Tracking of devices located on different floors (e.g., vertically displaced devices)
Lost & Found scenario

Device Density on the Floor-Map

Determining the usage of different regions of the premises through observation of the temporal concentration of various devices within these regions; e.g. by representing the premises floor-plan through a grid of a pre-determined resolution and maintaining a history of the density of various devices within different regions demarcated by the grid.

The methodology proposed, while on one hand duly complies with the well-known conventional (theoretical and statistical) modeling of the path-loss experienced with wireless signal propagation through free-space or other mediums, it is in particular configured to take into consideration the random fluctuations in the received signal strength (or respective indicator of the same) on account of temporal and/or spatial (or environmental) changes; which has posed as the primary concern in meeting this objective.

The basic components of the disclosed solution, for determining the location of a device based on its BLUETOOTH or WiFi signal detection, include the following:
Device(s) (mobile/fixed) to be detected (with either one or both of BLUETOOTH and WiFi interfaces enabled)
Sensor-devices: For the disclosed solution the Libelium (Model: Meshlium Scanner AP) sensors may be used; a minimum of 3 sensors are used to pursue location determination
Storage and Computing device(s)

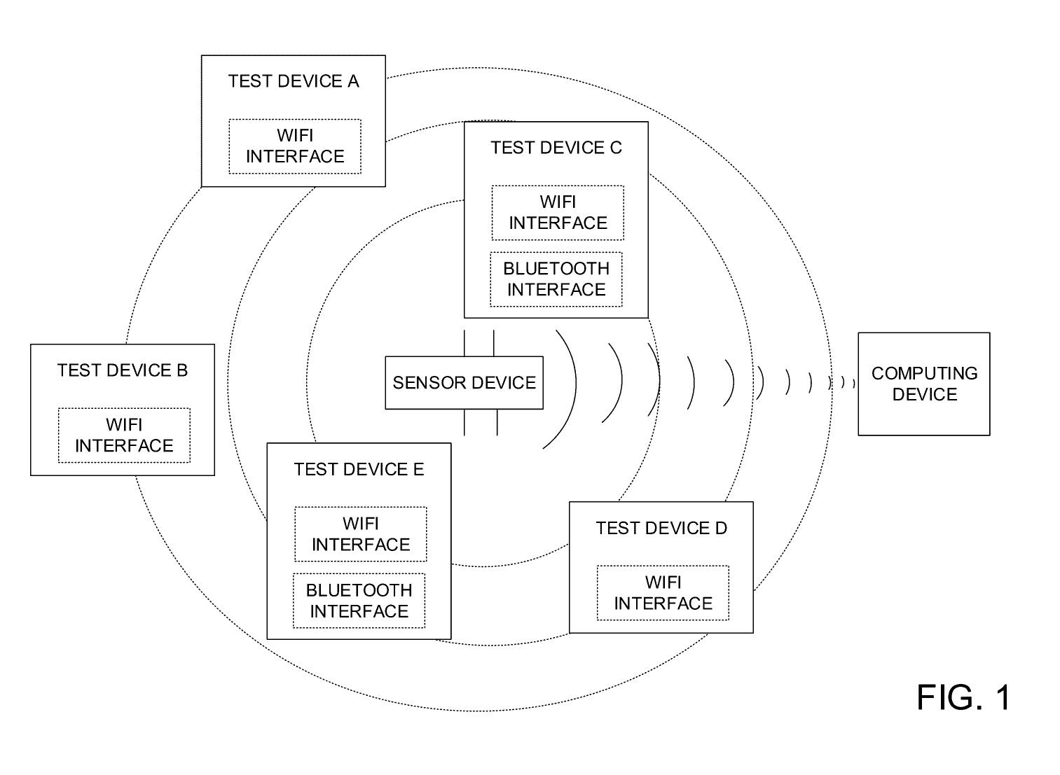

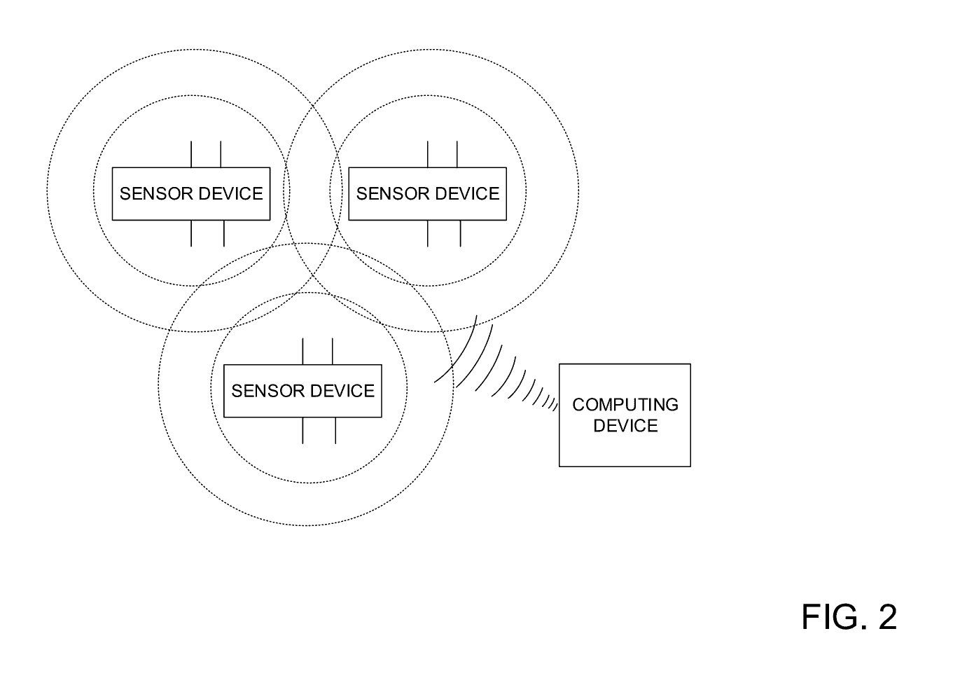

FIG. 1 illustrates the inter-connect between these components. It may be noted that the illustration includes a single sensor-device, using which the disclosed system may determine the expected radial distance at which the test-device is likely to be present. However, in order to estimate the location of the same, a minimum of 3 sensor-devices may be placed (preferably) equidistant from each other (e.g., at the vertices of an equilateral triangle); accordingly, the resulting setup may take the form illustrated in FIG. 2. It is to be understood that the antennae situated on the sensor-devices may be omni-directional, hence a doughnut-shaped radiation pattern (e.g., a series of concentric circles) is expected corresponding to each; therefore, in order to achieve the maximum coverage with respect to detection of the test-devices, these are positioned vertically on the sensors.

In general, it is to be understood that even by maintaining a fixed radial distance of the test-device relative to the receiving entity (the sensor-device in the disclosed setup), the randomness in the instantaneous recordings of the received signal-strength (or indicator of the same, viz. RSSI) is associated with the uncontrolled temporal and spatial variations in the ambient physical conditions (including the overall floor-layout, presence of walls/pillars/doors of different construction materials, innumerable fixed/mobile assets surrounding the two devices and thermal conditions, to name a few). Accordingly, to address these concerns, the disclosed solution comprises of a phase-wise approach, as follows:

(I) Phase-1: The first phase, also referred to as the learning phase and pursued primarily during the initial system deployment, comprises of determining an appropriate reference relationship between the RSSI and the Distance (between the test-device and the sensor-device). Since the physical positioning of any sensor device, relative to its surroundings, is likely to affect the measured signal parameter (RSSI), these are expected to be unique for each sensor-device at identical distance from the test-device; therefore, this reference relationship may be independently determined with respect to each of the installed sensor-devices. The same also holds true for deployment of the overall system at different locations. The methodology is explained below.

(II) Phase-2: The second phase comprises of events which are pursued in (or close-to) real-time on a recurring basis; these provide the final system outcome in the form of the expected location of the test-device(s). The chain of events, in the specified order, include determination of the distance values of the test-device(s) corresponding to each sensor-device, Statistical Positioning Determination (SPD) with respect to the three sets of distance values for the particular test-device(s) (carried out independently for each test-device) and eventually, determining the boundary, centroid and area of the Estimated Region-of-Presence (E-RoP) where the test-device is likely to be positioned. These series of events are detailed below.

Reference Relationship: RSSI Versus Distance

In principle, the variation in the RSSI with distance (between a chosen sensor- and the test-device) should rightfully predict the distance of any test-device from the sensor, based on its measured RSSI value, or vice-versa. Accordingly, numerous RSSI measurements are conducted at different radial as well as angular positions of the test-device relative to the sensor-device. Taking into consideration the temporal and spatial fluctuations in the observations, these measurements are recorded over extended durations (e.g., 2 hours) at each of the locations.

Statistical processing of the measured RSSI values aggregated over various angular positions, and for unique (radial) distance from the sensor-device, follows. The statistical measures in the form of the Median (or alternately, the Mean) and Standard-Deviation of the measurements as a function of the distance from the sensor provides the required basis to derive the reference relationship.

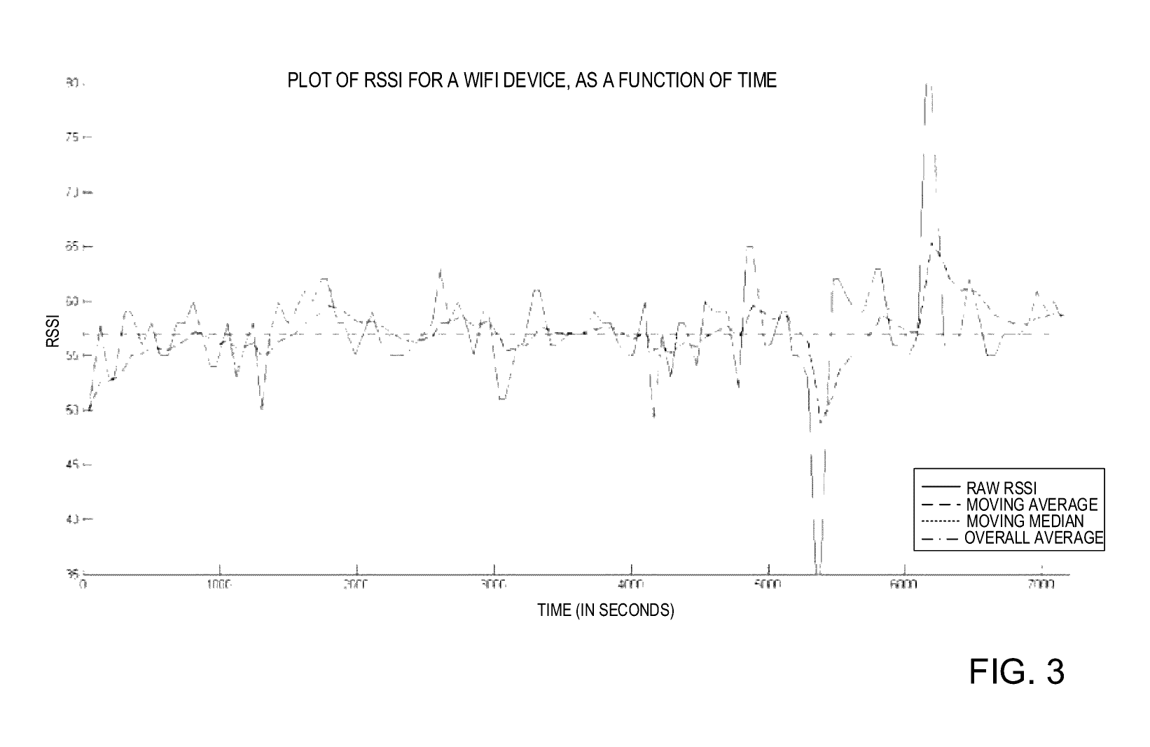

As can be observed in FIG. 3 the inherent variations in the measured (or raw), as well as statistically processed (Mean or Median) RSSI values, are not always conducive to estimating the distance of the test-device to a reasonable accuracy. Therefore, based on the expected variations about the Mean values (e.g., the Standard-Deviation) a degree of margin on either side of the Median (or Mean) RSSI values as a function of distance is used to construct the reference. In this respect, the following alternate approaches towards generation of the reference are available:

Piecewise Linear Approach

The successive (radial) distance values, spanning the coverage (or range; e.g., 25 m) of the sensor-scans, corresponding to which the measurements are conducted and statistical processing pursued, are each paired with their respective subsequent distance values. In general, terming each of these as a section (or apiece) of distance, a total of N distance values shall form (N−1) successive sections. Likewise, the corresponding RSSI statistical values are also paired and (N−1) sections formed, respectively. Treating each such section independently, a linear relation between the RSSI and distance is derived by computing the corresponding slope and intercept values, with known (processed) RSSI (duly accounting for the degree of margin) and the corresponding distance values.

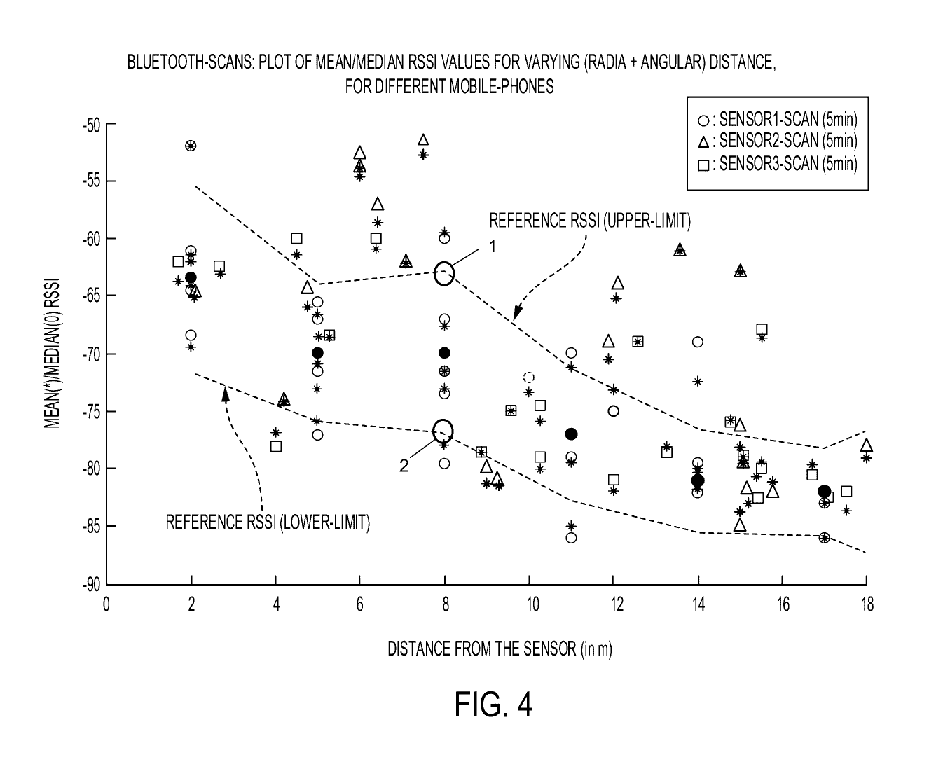

FIG. 4 illustrates as an example a reference curve, for the BLUETOOTH interface, constructed based on this approach. The plot of black-dots corresponds to the Median RSSI values, where the statistical processing, for any given radial distance, was pursued across the raw RSSI measurements obtained by placing the test-devices at different angular positions around Sensor-1 and for a period of 15 min at each position. The corresponding plot of the upper/lower margins, representing the reference boundaries is shown. The remaining blue/green/red plots correspond to the Mean/Median RSSI values determined over a 5 min duration. It is interesting to observe that while the majority of the red- and blue-plots fall within the limits posed by the two reference boundaries, the same does not hold true for the green-plot; this is an indication of the desirability to have a dedicated reference for the corresponding sensor-device. Consequently, the pair of linear parameters, viz. the slope and intercept values, corresponding to each section of the reference curve form the reference data-base using which one can determine the range of distance values over which the test-device is expected to be positioned around the sensor.

Curve-Fitting (Linear Regression) Approach

Considering the conventional and theoretical Path-Loss model(s) proposed in literature and commonly applied in various standardized wireless (PHY) technologies, this approach is based on applying linear regression to determine the model parameters, in particular, the path-loss exponent n. The received signal strength P̅ᵣ̅(d₀) at the reference distance d₀ is obtained through field measurements or using the free-space path-loss expression.

The following expression is the received signal model based on Log-normal Shadowing, where the received signal strength at distance d, e.g., Pᵣ(d) is not only governed by the separation between the two entities (Transmit and Receive devices) but also on the normally-distributed random variable χ_{σ}:

$${\overline{P}}_{r} ( d ) ∝ {( \frac{{d}_{0}}{d} )}^{n}$$

$${P}_{r} ( d ) = {\overline{P}}_{r} ( d ) + {χ}_{σ}$$

$$where , {\overline{P}}_{r} ( d ) = {\overline{P}}_{r} ( {d}_{0} ) - 10 n \cdot log ( \frac{d}{{d}_{0}} ) .$$

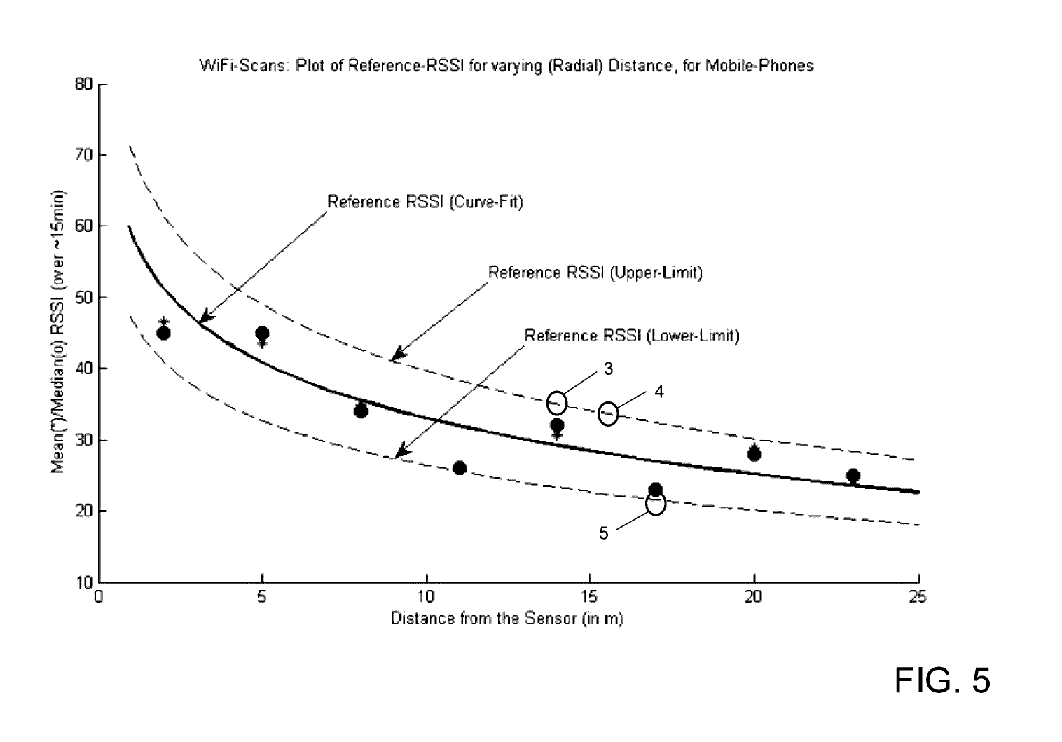

Through the knowledge of the Standard-Deviation values from the measured RSSI values, the upper and lower limits of the reference model are determined; accordingly, these serve to provide the range of distance values for any input RSSI value. FIG. 5 illustrates as an example a reference curve constructed based on this approach. Here, the plot of black-dots corresponds to the Median RSSI values for the WiFi interface.

Statistical Positioning Determination (SPD)

The overall process of SPD, falling under the purview of Phase-2, comprises of an ordered series of sub-processes which are explained below.

Statistical Processing of Raw Data

As illustrated through FIG. 3 and explained earlier, in order to counter the randomness in the measured RSSI and achieve greater reliability in the estimations, it is desirable to pursue some degree statistical processing (e.g., in the form of moving average) on the values reported in real-time by the sensors, respectively. However, it is noteworthy that the downside of any such processing is the inherent known delay in reporting the final outcome of the process; accordingly the same can be configured based on the applicable scenario. In general, the statistics based on measurements aggregated over a period of 5 min have resulted in reliable estimates.

Estimation of {dₘᵢₙ, dₘₐₓ}

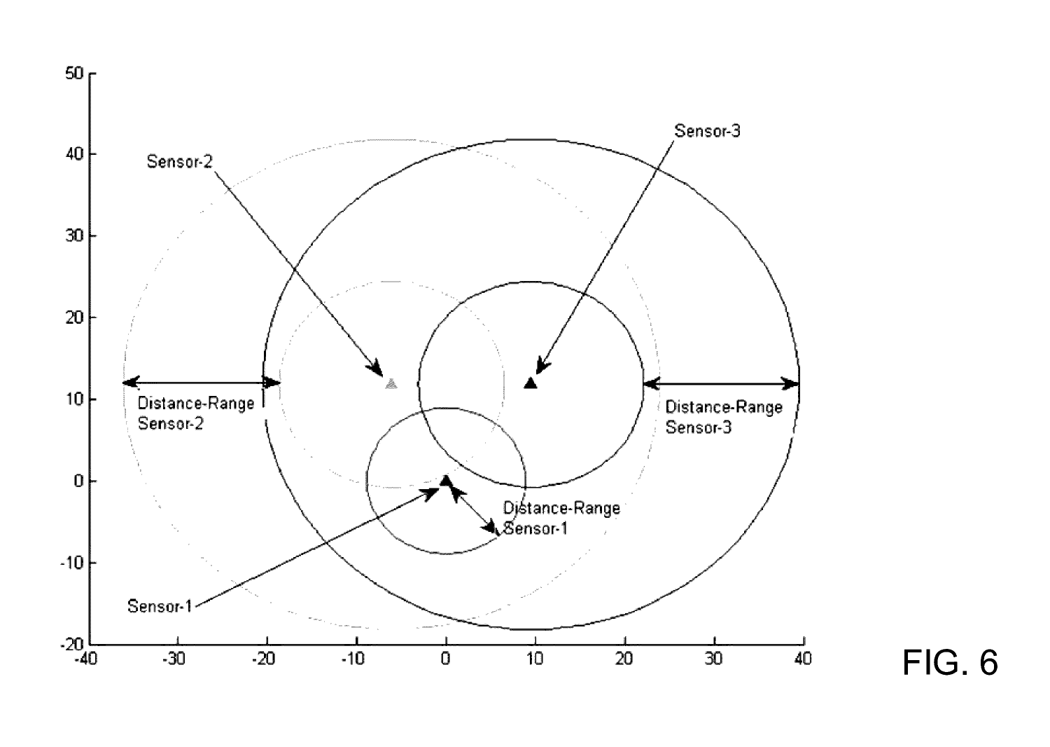

The statistically processed or instantaneous RSSI values are projected on the applicable reference boundaries, corresponding to each of the sensor-devices, to determine the range of distance values, in the form of {dₘᵢₙ, dₘₐₓ}. To state otherwise, the outcome of this process provides an estimate on the range of distance around respective sensor-device over which the test-device is expected to be present. Visualizing the same, the system has a pair of concentric circles or a doughnut-shaped region centered-around the particular sensor. Accordingly, with three sensors involved, there shall be 3 unique (with respect to thickness and size of the doughnut) regions, based on the respective pair of boundary values. The same is illustrated through FIG. 6; the three sensors, positioned on the X-Y plane with Sensor-1 as the origin, are marked by “triangle” markers corresponding to Sensor-1, Sensor-2 and Sensor-3, respectively. The corresponding ranges of distance values, in meters, are: {0 8.85}, {12.6 30} and {12.630}.

Determination of Estimated Region-of-Presence (E-RoP)

Observation of at-least three sets of distance ranges, corresponding to the RSSI values for the particular test-device (with respect to each of the sensor-devices), is required for determining the expected location of the test-device through the process of SPD. In this respect, it is necessary to ensure that the respective instantaneous/processed RSSI values are observed at identical time instants/intervals.

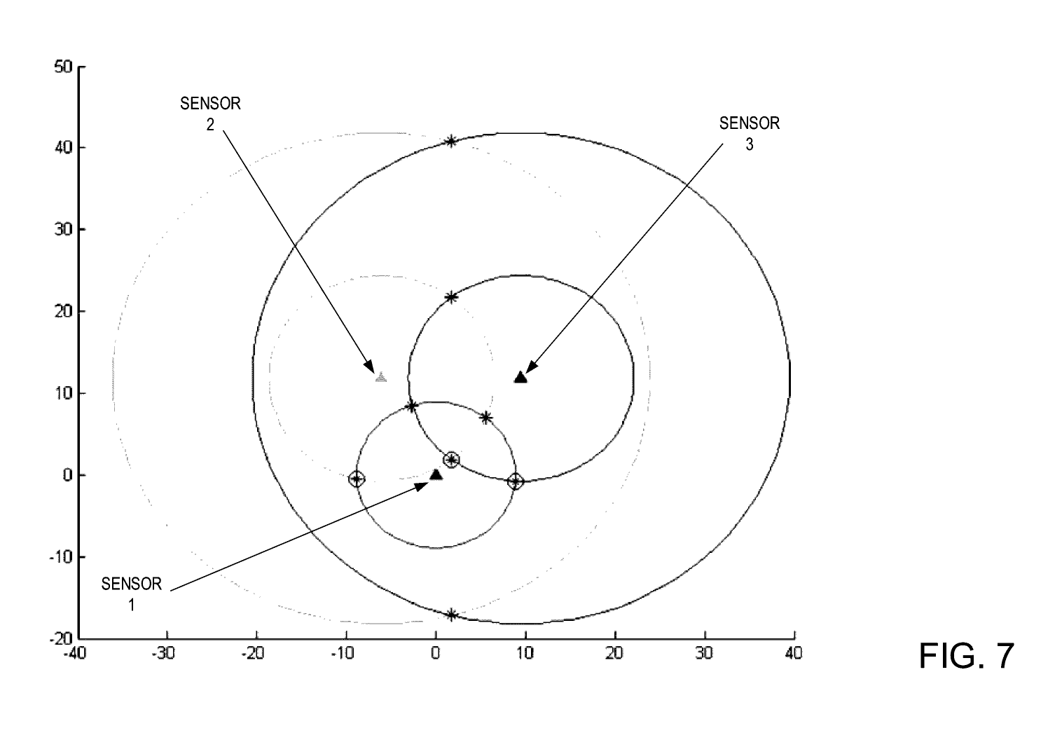

Now, with known distance boundaries, the points-of-intersection (PoIs) of each of the concentric circles centered on a given sensor with the remaining ones, corresponding to the other sensors, are determined. For a 3 sensors set-up, this amounts to up to 24 PoIs. Within this set, only the ones falling within the zone common to all the three doughnut-shaped regions are retained. FIG. 7 illustrates the overall PoIs (marked with “star”) and amongst these, the ones falling within the triangulated region (marked with “encircled-star”).

It should be observed with caution that mere knowledge of the valid set of PoIs does not ascertain determination of the E-RoP, as multiple enclosed regions can be formed out of this set. Hence, it is equally important to also determine the order of occurrence of these points in order to appropriately construct the E-RoP. This is accomplished by randomly selecting one of the points from the valid-set and alternately tracing and switching between the pair of circles forming these points. In the event of encountering multiple points on the same circle-to-be-traced, the nearest neighbor criterion is followed.

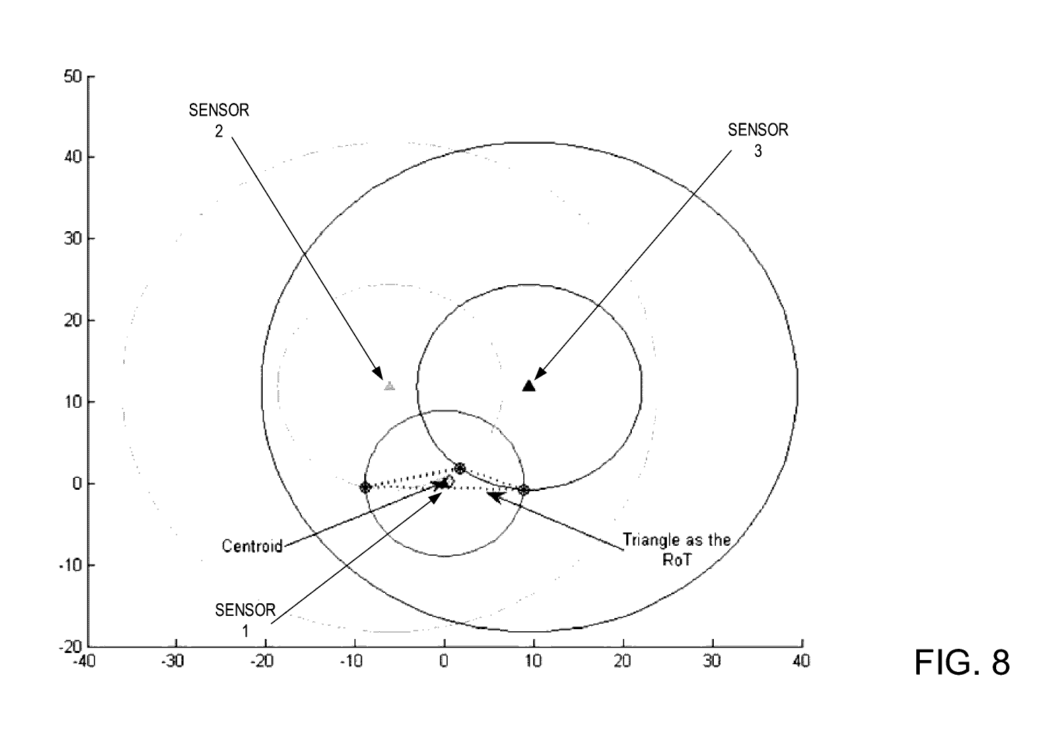

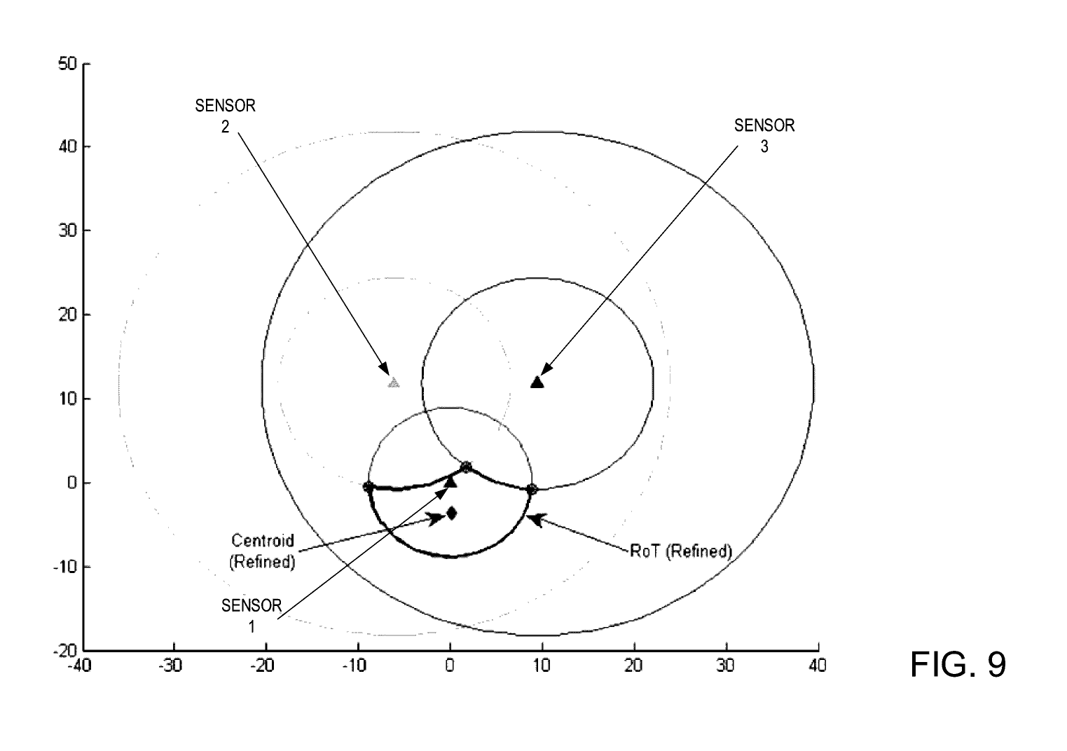

Lastly, while it is not entirely incorrect to form the E-RoP by joining the ordered list of valid PoIs through straight-lines thereby forming a polygon of equal number of edges as the number of PoIs enclosing it; the same however may in certain scenarios lead to unexpectedly significant inaccuracies in the projected E-RoP and consequently the estimated location of the test-device. This is illustrated through FIG. 8 Error! Reference source not found. where only 3 valid PoIs are obtained; as is quite apparent from the figure, a significant Region-of-Presence tends to get ignored by representing the region as a triangle, instead of its actual form (FIG. 9). With known ordered set of points encompassing the E-RoP, the corresponding Centroid and the Area of the E-RoP are computed.

System Implementation

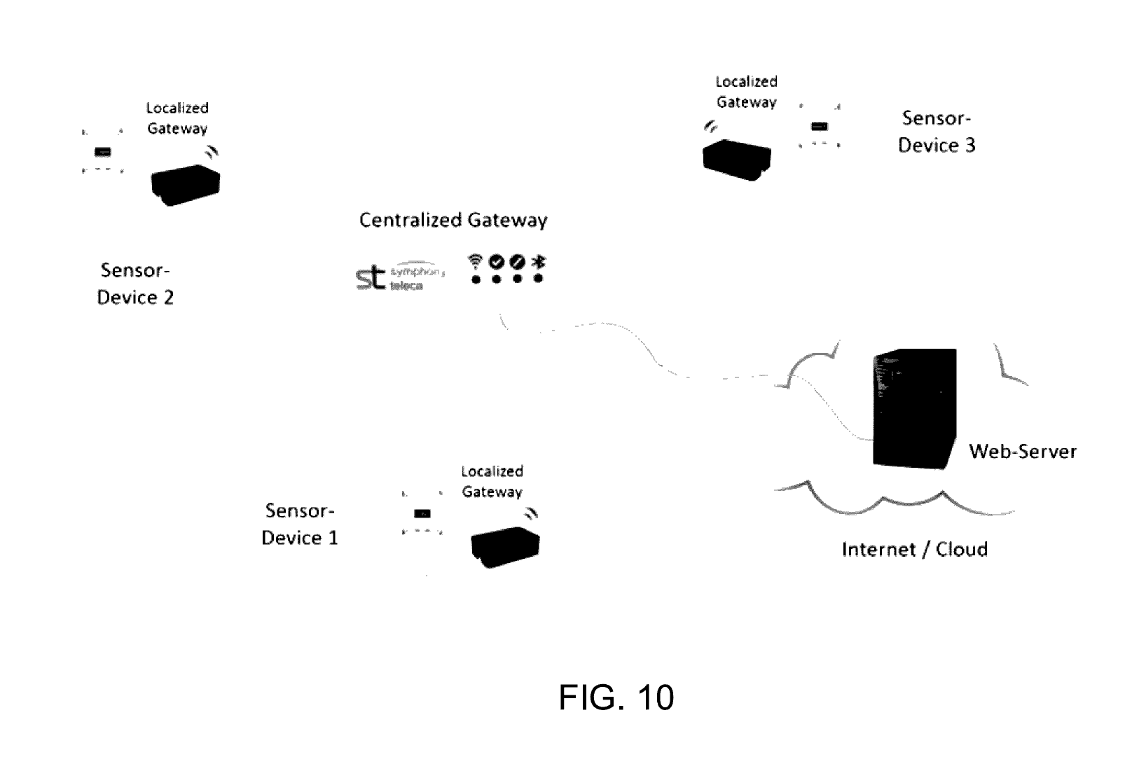

Following the proof-of-concept of the proposed solution and observing promising results with respect to the same, the solution is practically implemented. The following core components are examples of components that may be included in the implemented system:
i. Sensor-devices: a set of 3 Libelium (Model: Meshlium Scanner AP) sensors (incl. sufficient lengths of Cat6 Ethernet/LAN cables)
ii. RPi/Harman Gateway-devices: 3 sets of RASPBERRY PI boards (incl. WiFi (USB) dongle, Micro-SD card, Power-adaptor with cable and Casing, available from the Raspberry Pi Foundation, Caldecote, Cambridgeshire, UK) or 3 HARMAN-gateways (incl. Power-adaptor with cable, available from Harmon International Industries, Inc., Stamford, Conn., USA)
iii. Harman Gateway-device: a Harman-gateway (incl. Power-adaptor with cable) The interconnection of these components is illustrated through FIG. 10.

In this example, each of the sensor-devices is connected with a dedicated localized (RPi/Harman) Gateway device through a LAN-cable, while the latter connects with a centralized (Harman) Gateway device through a WiFi-interface. In this respect, the Sensor and the RPi/Harman Gateway, together, form an integrated WiFi-based sensor-device. Accordingly, three such sensors independently send their data to the centralized Gateway, respectively; in order to interact with these sensors, the centralized Gateway functions as a WiFi-Access Point (AP). Subsequently, to push the data to the Cloud/Web-Server, the centralized Gateway connects with the Internet via the Ethernet connection.

The allocation of various tasks involved in the overall process and the interaction between various components is stated as follows:

Scanning of devices and Data-collection: Each of the three sensors scan, on an ongoing basis, the various WiFi- and/or BLUETOOTH-enabled devices within its coverage area. The scanning interval in the sensor-devices is appropriately chosen to allow detection of maximum devices, whilst also preventing any sensor-specific operational hazards, e.g. overheating of components. The scanned data, comprising of each device's MAC-ID, time-stamp (with millisecond resolution) of the scan, the measured RSSI, device's vendor and type are some of the primary information-contents stored in each sensor's internal memory, in a My SQL file for example.

Statistical Data-Processing: The dedicated localized Gateway connected with each of the sensors fetches the scanned data in one of two scenarios:
Reference data-base generation: This is applicable in the event of generation of the reference RSSI versus Distance relationship, which is a non-real-time process, based on the settings in a configuration file (stored within the Gateway's memory). The data-base read from sensor's internal memory is parsed and processed accordingly, and reference data-base generated following either of the two methodologies listed above (e.g., the piecewise linear approach and/or the curve-fitting approach). The entire processing is performed in each of the localized Gateways, independently. Additionally, the data read from respective sensors may be retained in a respective Gateway's memory for future use. It may be noted that this process is expected to be pursued during the initial system deployment; any subsequent request/suggestion to conduct the same may only arise in the event of further fine-tuning the reference data-base.
Real-time Data processing: The scanned data is read, every specified interval, from each sensor's internal memory by its associated Gateway. After statistical processing of the raw/measured signal values, based on the configured interval and pertaining to each test-device (or MAC-ID), the processed RSSI value is applied on the pre-determined reference data-base to obtain the range of distance values. This process is applied on a recurring basis, independently for each scanned device and within each associated (localized) Gateway device. Accordingly the output from this operation and that from each of the associated Gateways comprises of the range of distance values for each scanned test-device, along with the associated time-stamp, against which this information holds true, and the respective sensor used in scanning the devices.

Location Determination: The final output from each of the localized Gateways is sent to the centralized (Harman) Gateway through a WiFi interface. Time synchronizing the information from the three WiFi-based sensors specific to each MAC-ID, the process of SPD within the centralized Gateway follows. The outcome of this processing, in the form of the Centroid and Area of the E-RoP, as well as the coordinates of the points encompassing the same (all with respect to each detected MAC-ID and for the specified time-stamp), are pushed to the Web-Server in a defined message. The knowledge of these parameters can then be used in a variety of manner based on the pre-defined use-case(s). Note: The above should be considered from the perspective of an implementation overview, as finer details e.g., memory overflow, time synchronization between different processes and in general, code optimization, may be adjusted.

The results based on the proposed solution for device location estimation are presented herein. In general, the absolute success in estimating any device's location entirely depends on the accuracy of the corresponding distance-range estimates. Additionally, the smaller the range of distance estimated with respect to each sensor-device, the finer is the resolution of the device's estimated location.

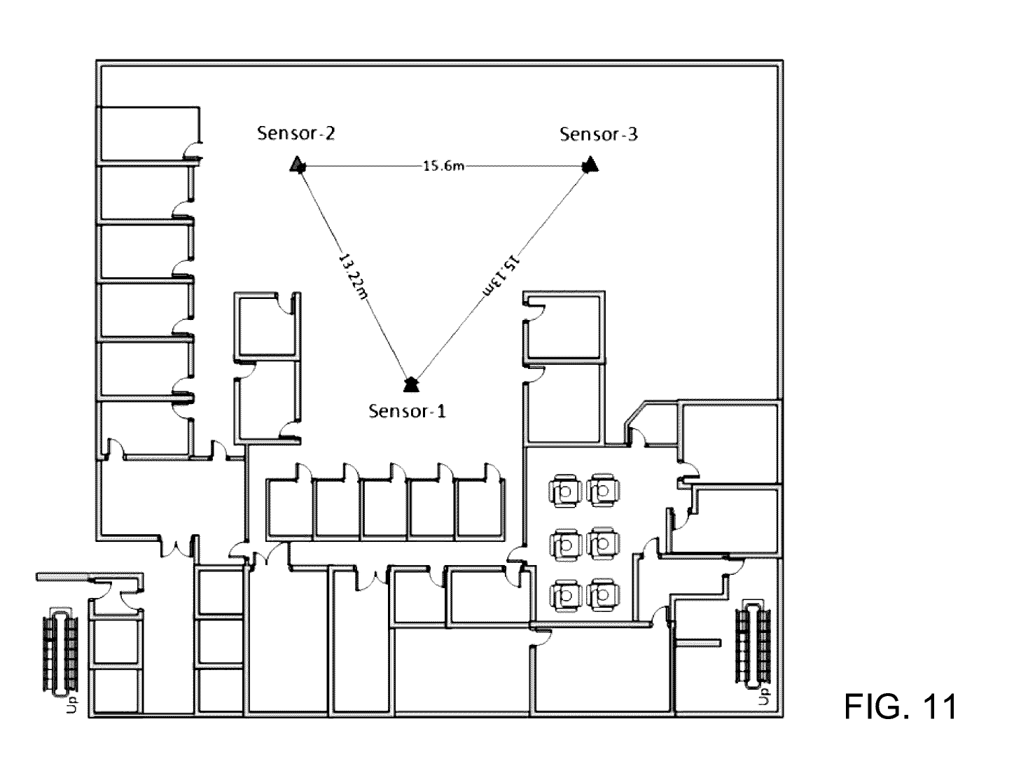

FIG. 11 illustrates the development-site's floor-plan with the three sensor-devices installed, as indicated by respective labeled markers (Sensor-1; Sensor-2; Sensor-3). Based on the same, numerous experiments were conducted by placing mobile phones (from different vendors) as test-devices at random locations within the premises (and within 30 m from each of the three sensors). Prior to the same, using similar devices, the reference relationship (e.g., RSSI versus Distance) was established with respect to Sensor-1.

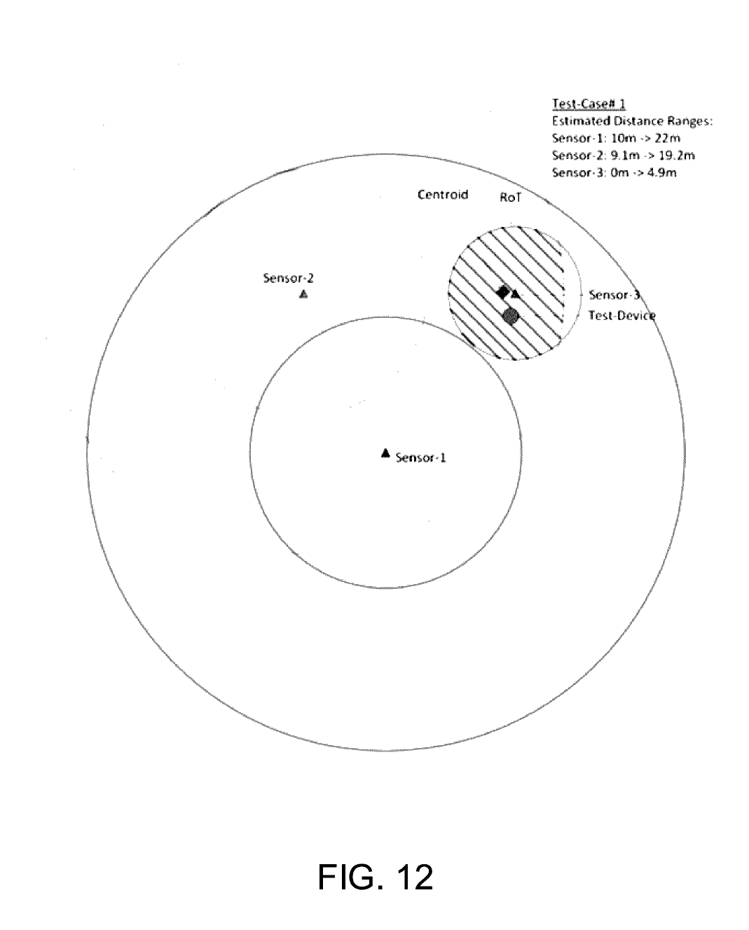

Table 1 and Table 2 list some of the results for both BLUETOOTH and WiFi interface types, respectively. The results are presented in the form of the intermediate outputs (e.g., the estimated range of distance, from each sensor) and the final outcome, viz. the coordinates of the Centroid of the E-RoP, for different test-devices placed at random locations within the coverage area; the corresponding graphical representation of the E-RoP is placed along with. The accuracy in estimating the device's location in each case can be visually observed with ease through these illustrations (FIGS. 12-19).

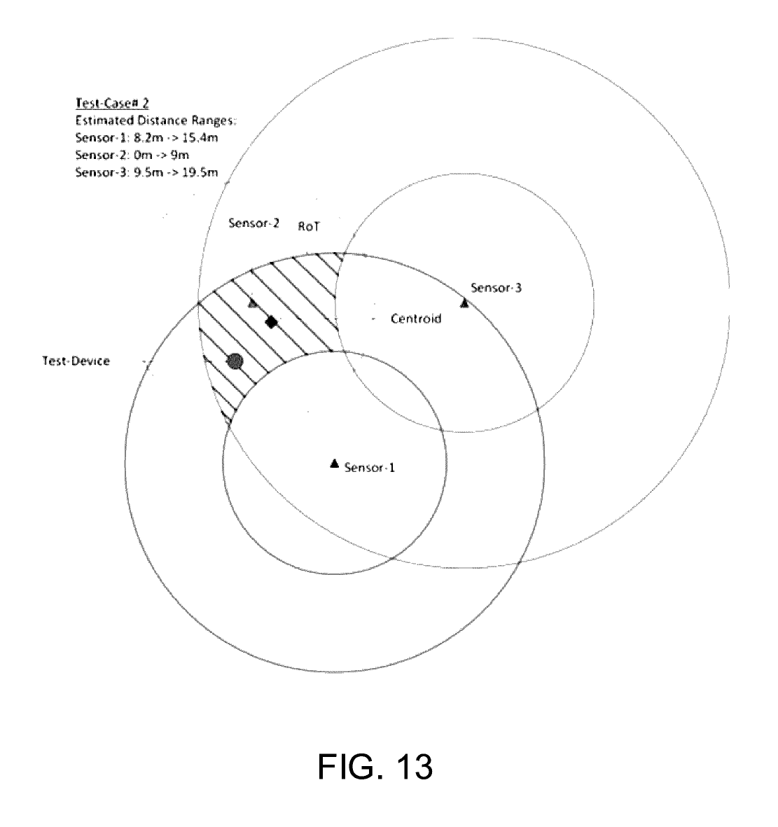

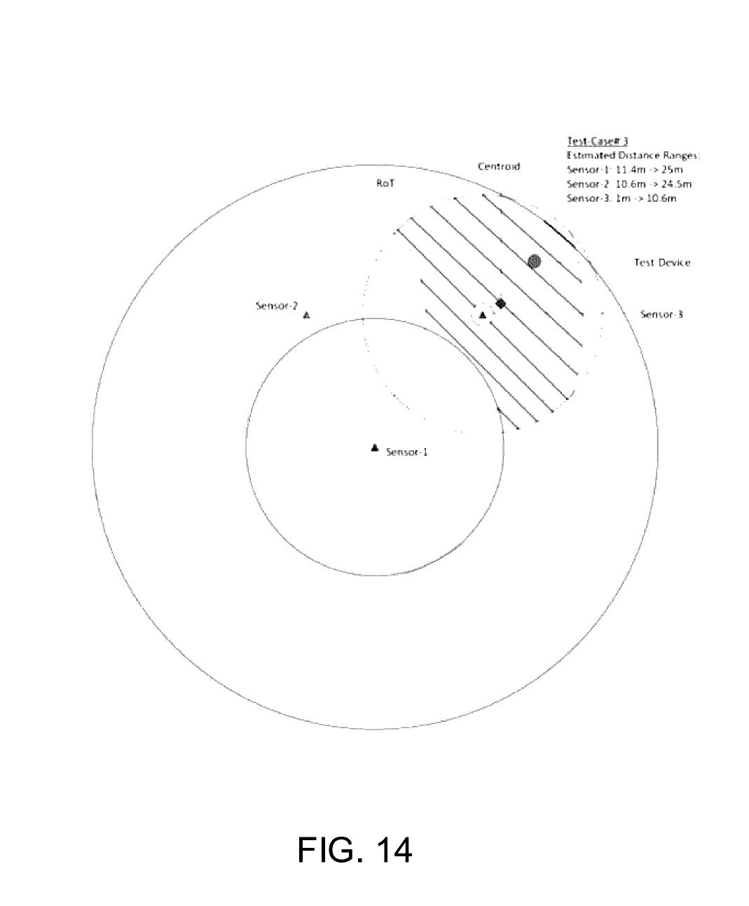

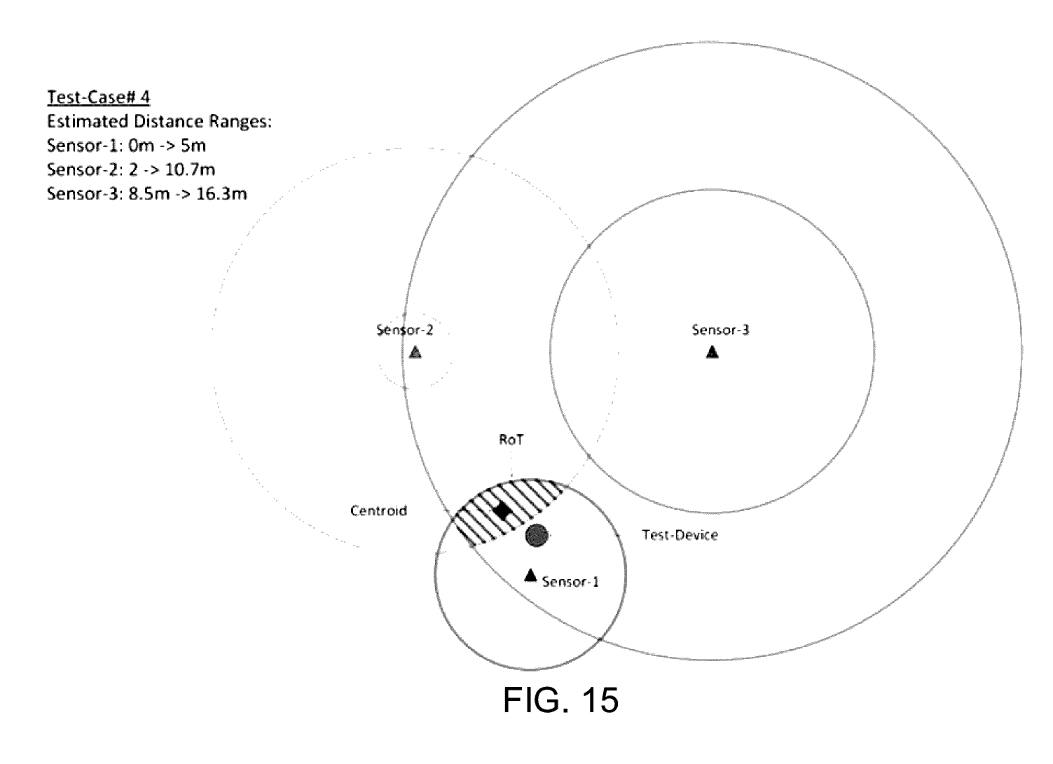

TABLE 1
Location estimation with respect to BLUETOOTH (mobile) devices

| | | Distance (in m) | | Distance (in m) | | Distance (in m) | | | | |
|---|---|---|---|---|---|---|---|---|---|---|
| Test- | | from Sensor-1 | | from Sensor-2 | | from Sensor-3 | | Centroid [x, y] | Actual Location | E-RoP |
| Case# | Device-ID | dₘᵢₙ | dₘₐₓ | dₘᵢₙ | dₘₐₓ | dₘᵢₙ | dₘₐₓ | of E-RoP | [x, y] of Device | illustrated |
| 1 | Mobile# 5 | 10 | 22 | 9.1 | 19.2 | 0 | 4.9 | [9.1, 11.8] | [9.2, 10.2] | FIG. 12 |
| 2 | Mobile# 2 | 8.2 | 15.4 | 0 | 9 | 9.5 | 19.5 | [−4.8, 10.2] | [−7.3, 7.6] | FIG. 13 |
| 3 | Mobile# 4 | 11.4 | 25 | 10.6 | 24.5 | 1 | 10.6 | [11.2, 13.2] | [14.2, 16.6] | FIG. 14 |
| 4 | Mobile# 5 | 0 | 5 | 2 | 10.7 | 8.5 | 16.3 | [−1.5, 3.5] | [0.3, 2.2] | FIG. 15 |

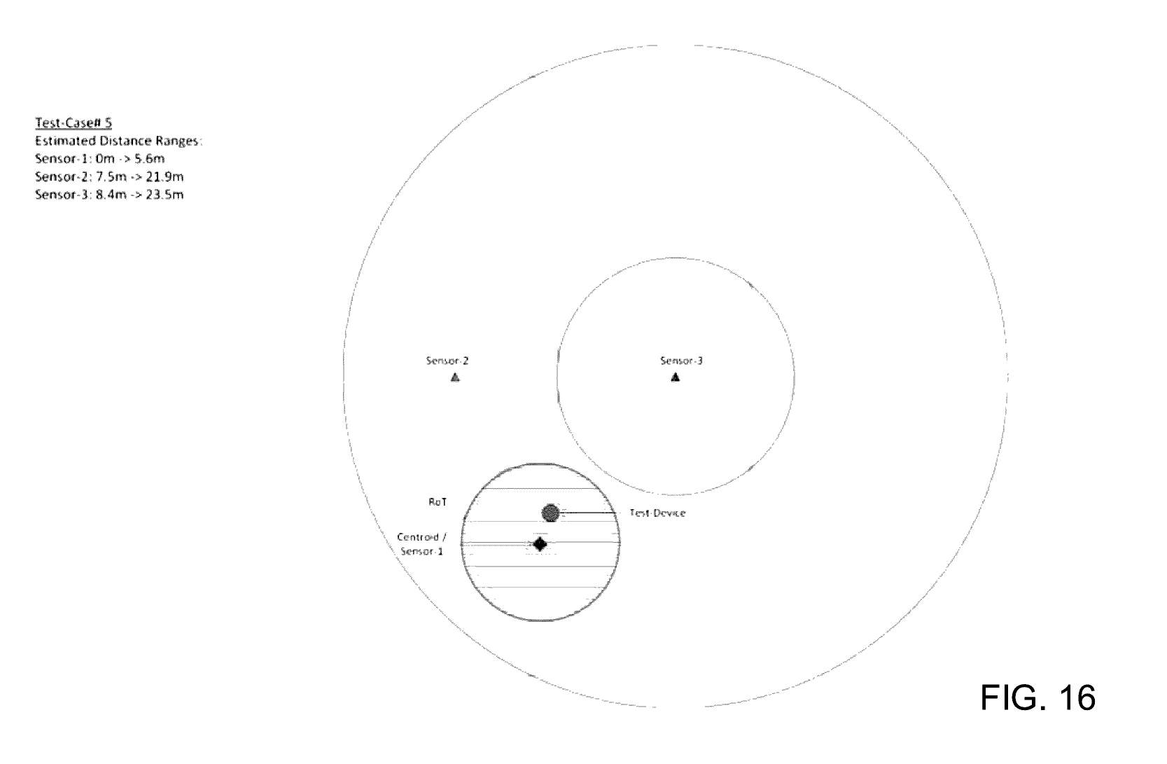

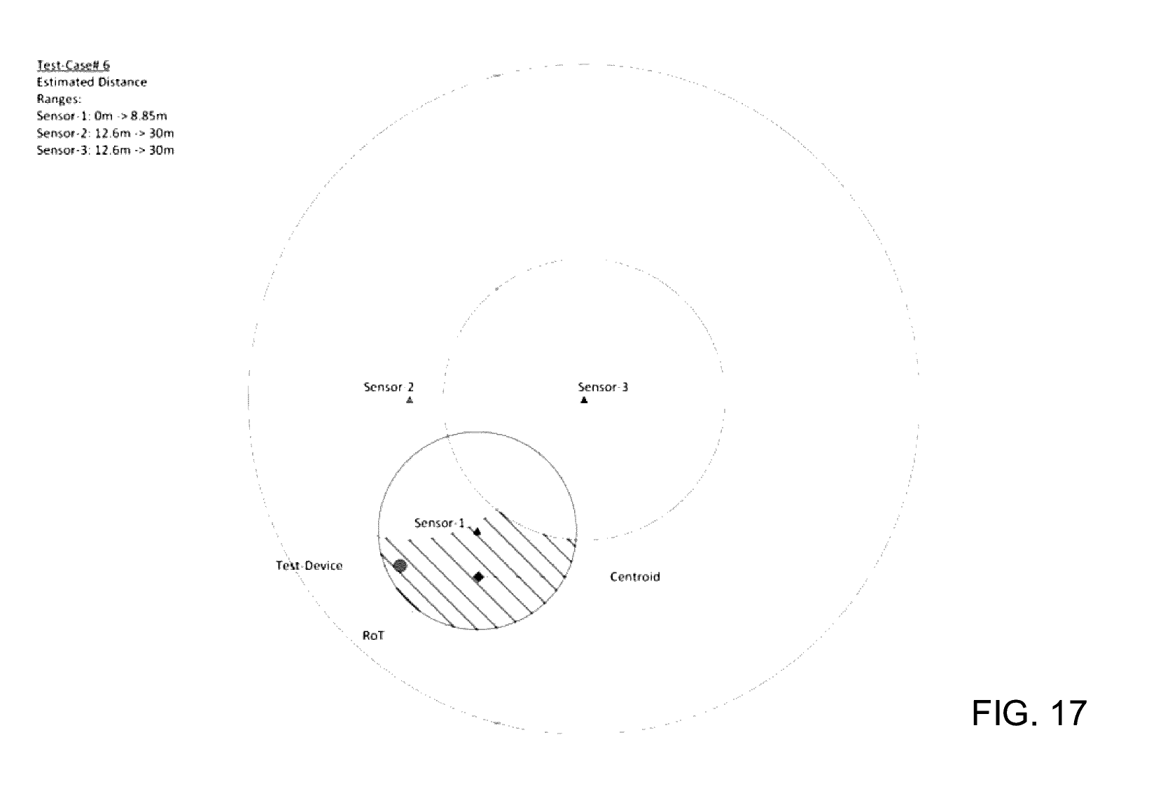

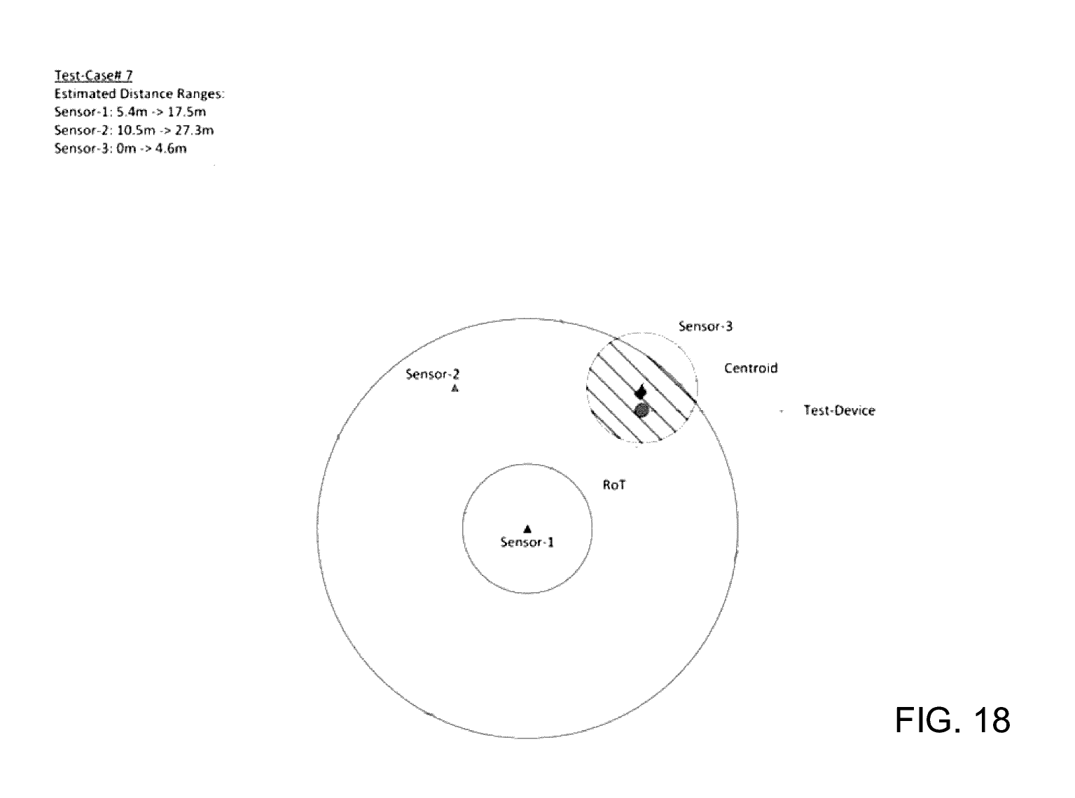

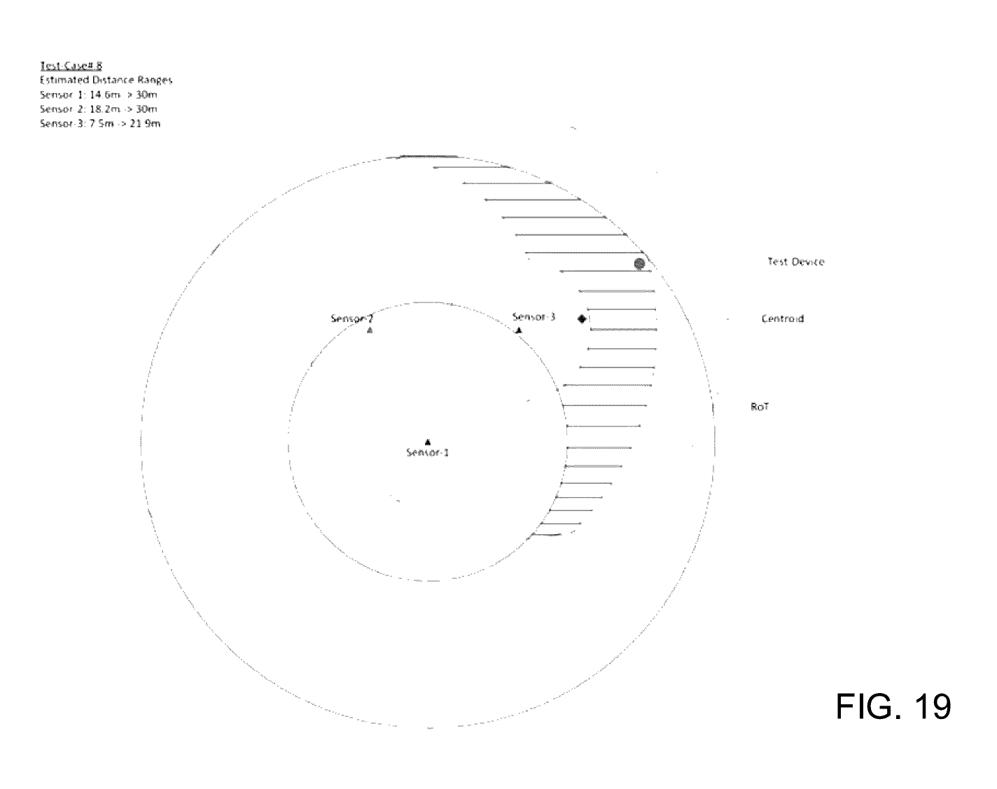

TABLE 2
Location estimation with respect to WiFi (mobile) devices

| | | Distance (in m) | | Distance (in m) | | Distance (in m) | | | | |
|---|---|---|---|---|---|---|---|---|---|---|
| Test- | | from Sensor-1 | | from Sensor-2 | | from Sensor-3 | | Centroid [x, y] | Actual Location | E-RoP |
| Case# | Device-ID | dₘᵢₙ | dₘₐₓ | dₘᵢₙ | dₘₐₓ | dₘᵢₙ | dₘₐₓ | of E-RoP | [x, y] of Device | illustrated |
| 5 | Mobile# 3 | 0 | 5.6 | 7.5 | 21.9 | 8.4 | 23.5 | [0, 0] | [0.8, 2.2] | FIG. 16 |
| 6 | Mobile# 4 | 0 | 8.85 | 12.6 | 30 | 12.6 | 30 | [0.16, −5.7] | [−6.9, −3] | FIG. 17 |
| 7 | Mobile# 5 | 5.4 | 17.5 | 10.5 | 27.3 | 0 | 4.6 | [8.9, 11.1] | [9.5, 10] | FIG. 18 |
| 8 | Mobile# 6 | 14.6 | 30 | 18.2 | 30 | 7.5 | 21.9 | [16, 12.4] | [22.1, 18.8] | FIG. 19 |

While it is desirable to obtain independent reference data-bases corresponding to each of the installed sensors, it may be noted that the results stated are based on the consideration of a single reference data-base (determined with respect to Sensor-1 alone) for all three sensors, on account of similarity in their positioning and surroundings, respectively, within the premises. Availability of sensor-specific reference data-bases may improve the final outcome; this is not only with respect to the chances of success in having the test-device located within the triangulated zone, but also in terms of the precision in estimating the device's location.

In the following illustrations (FIGS. 12-19), pertaining to position-determination, the shaded region corresponds to the Estimated Region-of-Presence (E-RoP), the circle-marker represents the actual location of the test-device, while the diamond-marker represents the location of the Centroid of this region. In general, for an object with uniform density, the Centroid is the Centre-of-Mass of the region it represents. Therefore in the present scenario the Centroid is projected as the likelihood of the device's location.

Despite the odds associated with the unreliability of the received signal strength with time and space, the proposed solution for location estimation based on RSSI can determine to a reasonable success and accuracy the position of a BLUETOOTH- and/or WiFi-enabled device in an entirely non-intrusive manner. The accuracy of the test-device's estimated location is largely governed by the accuracy of the distance (or range of distance) value(s) from each of the sensor-devices; accordingly, the use of an appropriately created reference data-base (specific to the interface, device-type and locale) is essential to the accurate functioning of the proposed solution.

In particular, on account of the inherent temporal variations in the received signal strength, a degree of low-pass filtering (statistical processing) may be performed on the raw (or instantaneous) RSSI values observed across some pre-defined duration (e.g., spanning a few minutes) in order to remove the high-frequency/fluctuating content; the solution-outcome shall accordingly be based on the processed values.

In general, the range (radial distance) corresponding to reliable detection of WiFi- and BLUETOOTH-enabled devices, for the sensor-device employed, is observed to be approximately 25 m and 20 m, respectively. Based on the same, the serviceable areas of the installed system (set of three sensor-devices) are approx. 17000 ft² and 11000 ft², respectively.

The proposed solution is a self-contained and entirely non-intrusive device locating and tracking methodology; its functioning does not rely on installing some Client-side App (application) and/or other pre-requisites pertaining to personal details (e.g., SIM card based tracking solutions). Further, the solution is applicable to delivering location based services in in-building, multi-floored environments. Accordingly, the disclosure provides performance increases for network systems by allowing location estimations to be performed for scanned devices without tying up computing resources on the scanned devices. In this way, the operation of the scanned devices may be improved by removing computer processing loads during location estimation. Further, the operation of the sensor devices may be improved by reducing time and bandwidth usage, as the sensor devices do not communicate with a client-side application on the scanned devices.

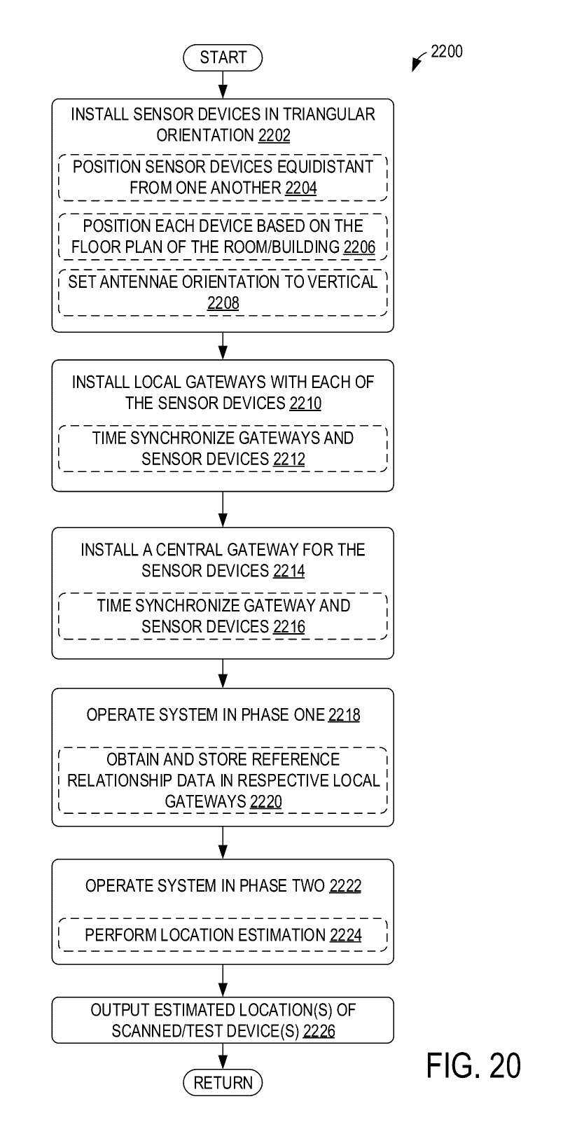

FIG. 20 is a flow chart of a method 2200 for determining an estimated region of presence of scanned/test devices. At 2202, the method includes installing sensor devices (e.g., three sensor devices, such as sensor devices shown in FIG. 2) in a triangular orientation/formation. As indicated at 2204, the sensor devices may be positioned equidistant from one another. As an example, inter-device spacing may range from 10 to 15 meters in one example, or approximately 12 meters from one another in a more particular example. As indicated at 2206, the sensor devices may optionally be positioned based on the floor plan of the environment (e.g., room/building) in which the sensor devices are to be installed. As indicated at 2208, the antennae on the sensor devices are positioned in a vertical orientation in order to provide a uniform radiation/reception pattern when the antennae are omni-directional. Further settings that may be adjusted for the sensor devices include updating firmware for the sensor devices, pre-setting the sensor devices with respect to scanned results storage (e.g., storing prior-determined data local to the sensor devices and/or within a storage device in communication with the sensor devices), and time synchronizing the sensor devices with respect to one another.

At 2210, the method includes installing local gateways with each of the sensor devices. As indicated at 2212, the local gateways may be time synchronized with the sensor devices so that a common time reference may be used between the components. At 2214, the method includes installing a central gateway for the sensor devices. As indicated at 2216, the central gateway may be time synchronized with each of the sensor devices. For example, the central gateway may be configured to communicate with the local gateways, as described in more detail above with respect to FIG. 10.

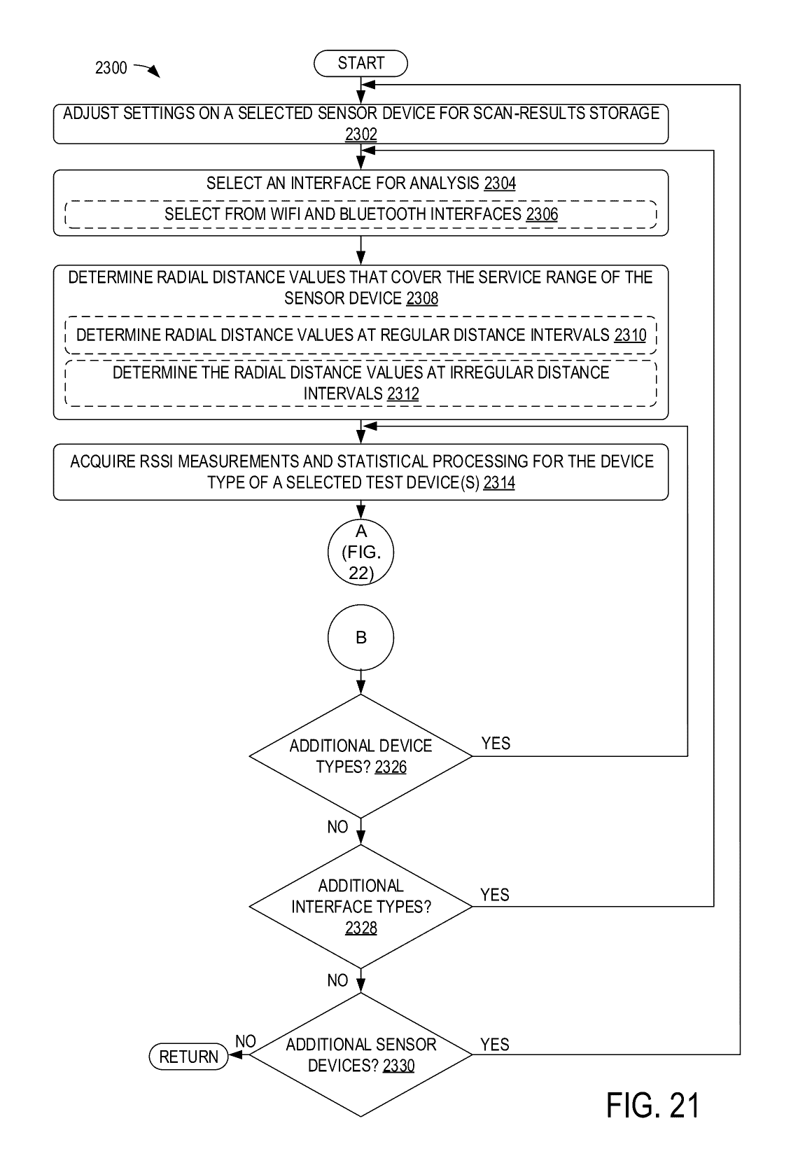

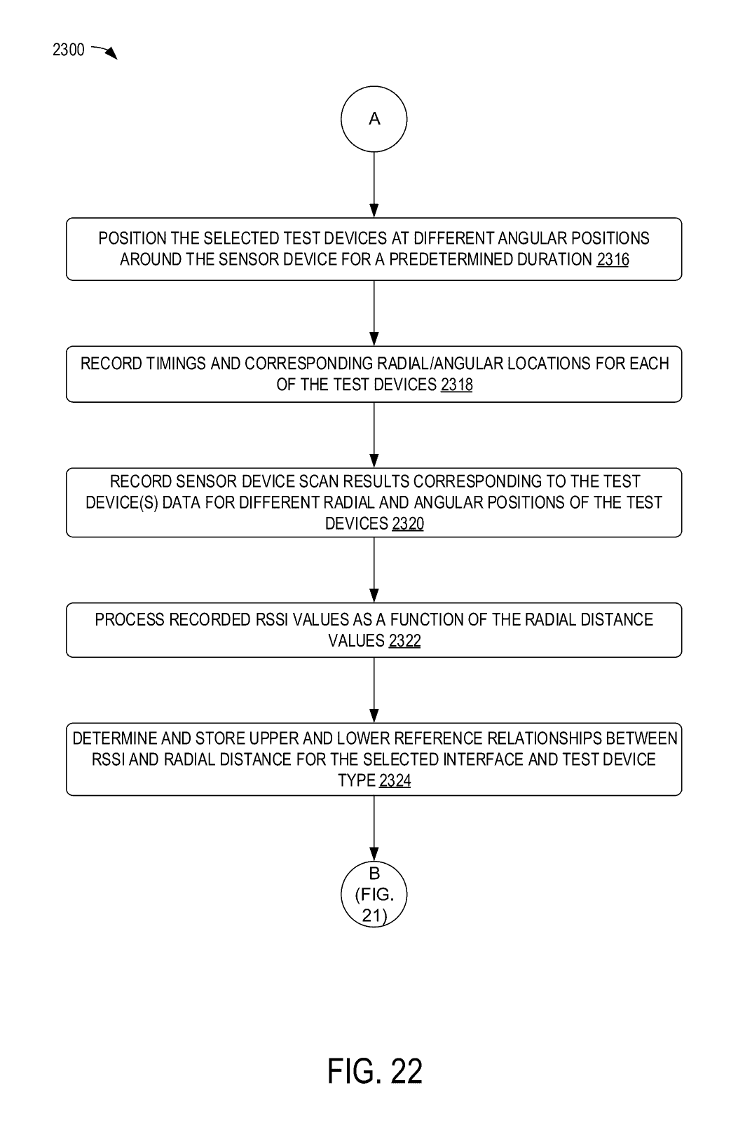

At 2218, the method includes operating the system in a first phase of operation. As indicated at 2220, the first phase may include obtaining and storing reference relationship data in respective local gateways. The first phase of operation is described in more detail below with respect to FIGS. 21 and 22. In the first phase of operation, devices of different types and makes (e.g., smartphones, laptops, tablets, routers of different vendors, etc.) may be used as test devices.

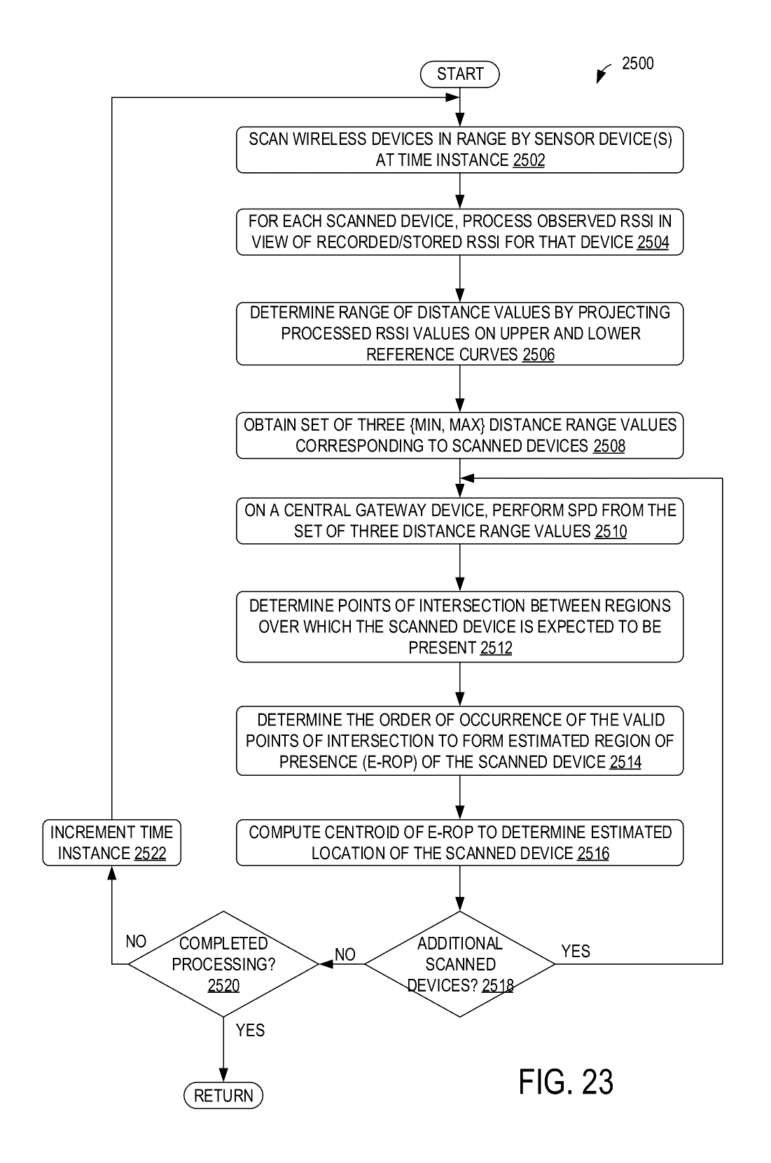

At 2222, the method includes operating the system in a second phase of operation. As indicated at 2224, the second phase may include performing a location estimation of scanned/test devices. The second phase of operation is described in more detail below with respect to FIG. 23. In the second phase of operation, a database may be generated, the database of devices and associated estimated locations at different times (e.g., as a projection of representations of the devices/estimated locations on a floor map for an environment—such as a room/building—in which the sensor devices are located).

At 2226, the method includes outputting the estimated location(s) of scanned/test device(s). For example, the estimated locations may be based on the test results obtained at 2218 (in the first phase of operation) and the location estimation results obtained at 2222 (in the second phase of operation). The estimated location(s) of the scanned/test device(s) may be used to control the scanned/test devices, communicated to a requesting device/server, and/or otherwise used to adjust operation of a device and/or network.

FIGS. 21 and 22 are flow charts of a method 2300 for obtaining and storing reference relationship data as a learning phase of the method 2200 illustrated in FIG. 20. For example, method 2300 may be performed at block 2218 of FIG. 20. At 2302, method 2300 includes adjusting settings on a selected sensor device for scan results storage. For example, the selected sensor device may be configured to communicate with a storage device for holding results of subsequent or prior scanning operations. In additional or alternative examples, memory locations local to the sensor device may be allocated to hold the results of prior or subsequent scanning operations.

At 2304, the method includes selecting a wireless interface for analysis (e.g., a WI-FI or BLUETOOTH wireless interface, as indicated at 2306) to determine reference relationships for that interface. At 2308, the method includes determining radial distance values that cover the service range of the sensor device. For example, the radial distance values may be determined at regular distance intervals, as indicated at 2310, and/or at irregular distance intervals, as indicated at 2312.

At 2314, the method includes acquiring Received Signal Strength Indication (RSSI) measurements and statistical processing results for a device type of one or more selected test devices. For example, different types of test devices may produce different results due to the configuration of the test devices. In one example, different types of devices may have different antenna strengths or configurations (e.g., smartphones versus laptops, devices with external antennae versus devices with internal antennae, etc.). The method continues at block 2316 of FIG. 22, where the method includes positioning the selected test devices at different angular positions around the sensor device for a predetermined duration. For example, a predetermined duration may be 60 minutes for one round of scanning operations. The test devices may be positioned in order to provide a comprehensive 360 degree coverage around the sensor device.

At 2318, the method includes recording start/stop timings and corresponding radial/angular locations for each of the selected test devices. The recorded timings and corresponding locations may be acquired for a complete range of radial distance values, and for all of the angular positions for each radial distance. For example, for a sensor device range of x meters, test devices may be positioned in different radial locations ranging from approximately 0 to x meters away from the sensor device. In order to measure the full range of radial locations, the RSSI value of each test device at each location from approximately 0 to x meters away from the sensor device may be measured by the sensor device, such that the “full range” of radial locations may include radial locations at regular or irregular intervals ranging from approximately 0 to x meters away from the sensor device. Measurements for different angular positions at a given radial location may be acquired by positioning multiple test devices at the same radial location and at different angular positions, or by positioning a test device at the radial location in different angular positions, taking RSSI measurements at each angular position.

At 2320, the method includes recording sensor device scan results corresponding to the test device(s) data for different radial and angular positions of the test devices. At 2322, the method includes processing recorded RSSI values as a function of the radial distance values. For example, the RSSI values (e.g., over the predetermined duration and for the different angular positions) may be statistically processed (e.g., determining a mean, median, standard deviation, etc.) as a function of the radial distance values.

At 2324, the method includes determining and storing upper and lower reference relationships between RSSI and radial distance for the selected interface and test device type. For example, a reference curve may be generated, using a piecewise-linear approach or a curve-fitting (linear regression) approach for processing the recorded data. The relationships between the sensor device, interface type, and test device type may be stored in a database (e.g., local to the sensor device or remote/external to and in communication with the sensor device).

The method continues at block 2326 in FIG. 21, the method including determining if there are additional test device types to analyze. If additional test device types are to be analyzed (e.g., “YES” at 2326), the method returns to 2314 to acquire RSSI measurements and process the measurements for the newly-selected test device type. If no additional test device types are to be analyzed for the selected interface type (e.g., “NO” at 2326), the method proceeds to 2328 to determine if additional interface types are to be analyzed. If additional interface types are to be analyzed (e.g., “YES” at 2328), the method returns to 2304 to select a new interface type and proceed with analysis for that interface type. For example, some test devices may have multiple interface types (e.g., a WI-FI and a BLUETOOTH interface), and thus may be tested in multiple rounds of analysis using the different interfaces.

If no additional interface types are to be analyzed for the selected sensor device (e.g., “NO” at 2328), the method proceeds to 2330 to determine if any additional sensor devices are to be analyzed. If additional sensor devices are to be analyzed (e.g., “YES” at 2330), the method returns to 2302 to perform the method for the newly selected sensor device. If no additional sensor devices are to be analyzed (e.g., “NO” at 2330), the method returns (e.g., to block 2222 of FIG. 20).

FIG. 23 is a flow chart of a method 2500 for estimating a location of scanned/test devices as a location estimation phase of the method illustrated in FIG. 20. For example, method 2500 may be performed at block 2222 of FIG. 20 (e.g., after performing method 2300 of FIGS. 21 and 22). At 2502, method 2500 includes scanning wireless devices in range of one or more sensor devices at a time instance. At 2504, the method includes, for each scanned device (e.g., each MAC-ID), processing (e.g., statistically processing) observed RSSI (e.g., observed in real-time) in view of recorded/stored RSSI values for that scanned device (e.g., where the observed RSSI may be interpreted based on the recorded/stored RSSI). The recorded/stored RSSI values for that scanned device may include values that are recorded during phase two of method 2200 and prior to measuring/determining the currently-observed/instantaneous RSSI values, recorded in real time as an instantaneous RSSI value, and/or recorded during phase one of method 2200 of FIG. 20. For example, the observed RSSI may be statistically processed based on a running average computation over a pre-defined period (e.g., 5 minutes).

At 2506, the method includes determining a range (e.g., {min, max}) of distance values by projecting the processed RSSI values (e.g., processed at 2504) on upper and lower reference curves (e.g., the reference curves generated via method 2300 of FIGS. 21 and 22, corresponding to the sensor device, the interface type, and the scanned device type). The range of distance values may be performed for all scanned devices over the scanning interval, and independently for all of the sensor devices (e.g., all three of the sensor devices in the triangular formation).

At 2508, the method includes obtaining a set of three {min, max} distance range values corresponding to the scanned devices for the time interval. At 2510, the method includes, on a central gateway device (e.g., the central gateway device of FIG. 10), performing statistical positioning determination (SPD) from the available set of three distance (range) values for each of the scanned devices at the time instance (e.g., time stamped with the time instance). At 2512, the method includes determining points of intersection between regions over which the scanned device is expected to be present. At 2514, the method includes determining the order of occurrence of the valid points of intersection to form an estimated region of presence (E-RoP) of the scanned device. For example, the order of occurrence may be determined by randomly selecting one of the points from the valid-set and alternately tracing and switching between the pair of circles forming these points. In the event of encountering multiple points on the same circle-to-be-traced, the nearest neighbor criterion may be followed to determine the order of occurrence. At 2516, the method includes computing a centroid of the E-RoP to determine the estimated location of the scanned device.

At 2518, the method includes determining if additional scanned devices bearing identical time-stamp are to be analyzed (e.g., to determine associated estimated locations of the additional scanned devices). If additional scanned devices are to be analyzed (e.g., “YES” at 2518), the method returns to 2510 to perform SPD analysis for the additional scanned device. If no additional scanned devices are to be analyzed, the method proceeds to 2520 to determine whether processing of the scanned devices is completed. If processing is not completed (e.g., if estimated locations for additional time instances are to be determined, “NO” at 2520), the method proceeds to 2522 to increment the time instance (e.g., to evaluate measurements time stamped with an incremented value) and returns to 2502 to scan the wireless devices at the incremented time instance. If processing is completed (e.g., “YES” at 2520), the method returns (e.g., to block 2226 of FIG. 20).

The systems and methods described above also provide for a device locating system comprising three or more sensor devices, a processor, and a storage device storing instructions executable to determine an estimated location of a scanned device based on a received signal strength indication (RSSI) value for the scanned device measured by at least three of the three or more sensor devices and processed in view of previously-recorded RSSI values for the scanned device and/or instantaneous RSSI values of the scanned device, and output the estimated location of the scanned device to a computing device for controlling operation of the computing device. In some examples, the device locating system may operate using one or more sensor devices, or one or more devices comprising three or more sensor devices, in the manner described above for the three or more sensor devices. In a first example of the device locating system, the system may additionally or alternatively include the system wherein the scanned device is a wireless-enabled device, and the previously-recorded RSSI values for the scanned device comprise previously-recorded RSSI values for a selected wireless interface type of the scanned device. A second example of the device locating system optionally includes the first example, and further includes the system wherein the selected wireless interface type is one of a WI-FI interface and a BLUETOOTH interface. A third example of the device locating system optionally includes one or both of the first and the second examples, and further includes the system wherein the instructions are further executable by the processor to determine a range of distance values for the scanned device by projecting the processed RSSI value onto a reference curve corresponding to the previously-recorded RSSI values for the scanned device. A fourth example of the device locating system optionally includes one or more of the first example through the third example, and further includes the system wherein the scanned device is a first scanned device, and wherein the reference curve further corresponds to previously-recorded RSSI values for additional scanned devices having the same interface type and device type as the first scanned device. A fifth example of the device locating system optionally includes one or more of the first example through the fourth example, and further includes the system wherein the reference curve is generated based on one or more of a piecewise-linear approach and a linear regression approach to determine upper and lower reference relationships between RSSI measurements and radial distances. A sixth example of the device locating system optionally includes one or more of the first example through the fifth example, and further includes the system wherein the instructions are further executable by the processor to obtain a set of distance range values corresponding to scanned devices scanned by each of the three or more sensor devices. A seventh example of the device locating system optionally includes one or more of the first example through the sixth example, and further includes the system wherein the three or more sensor devices each include a respective local gateway device, and the device locating system further comprising a central gateway device in communication with each of the respective local gateway devices. An eighth example of the device locating system optionally includes one or more of the first example through the seventh example, and further includes the system wherein the instructions comprise first instructions, and wherein the central gateway device comprises a gateway processor and a gateway storage device storing second instructions executable by the gateway processor to perform a statistical positioning determination (SPD) from the set of distance range values. A ninth example of the device locating system optionally includes one or more of the first example through the eighth example, and further includes the system wherein one or more of the first instructions and the second instructions are further executable to determine points of intersection between selected scanning regions of each of the three or more sensor devices, the selected scanning regions indicating regions at which the scanned device is expected to be present. A tenth example of the device locating system optionally includes one or more of the first example through the ninth example, and further includes the system wherein one or more of the first instructions and the second instructions are further executable to determine an order of occurrence of the points of intersection to generate an estimated region of presence of the scanned device. An eleventh example of the device locating system optionally includes one or more of the first example through the tenth example, and further includes the system wherein one or more of the first instructions and the second instructions are further executable to determine a centroid of the estimated region of presence of the scanned device, the estimated location of the scanned device corresponding to the centroid of the region of presence of the scanned device.

The systems and methods described above also provide for a method of estimating a location of a scanned device that is scanned by a sensor device, the method comprising identifying, at the sensor device, a received signal strength indication (RSSI) value associated with the scanned device, estimating, with the sensor device, a location of the scanned device based on the identified RSSI and one or more previously-identified RSSI values, and outputting the estimated location of the scanned device to a computing device for controlling operation of the computing device. In a first example of the method, the method may additionally or alternatively include the method further comprising processing the identified RSSI value for the scanned device in view of the one or more previously-identified RSSI values. A second example of the method optionally includes the first example, and further includes the method further comprising projecting the processed RSSI value on one or more reference curves, the reference curves being generated based on relationship data previously obtained by the sensor device, and the relationship data indicating a relationship between the one or more previously-identified RSSI values and associated radial distances between the sensor device and one or more test devices previously scanned by the sensor device. A third example of the method optionally includes one or both of the first example and the second example, and further includes the method further comprising, for each of a plurality of sensor devices, determining distance values for the scanned device based on the projection of the processed RSSI value on one or more reference curves for that sensor device. A fourth example of the method optionally includes one or more of the first example through the third example, and further includes the method further comprising determining an estimated region of presence of the scanned device based on the distance values determined by each of the plurality of sensor devices. A fifth example of the method optionally includes one or more of the first example through the fourth example, and further includes the method further comprising computing a centroid of the estimated region of presence of the scanned device and determining the estimated location of the scanned device as corresponding to the centroid of the estimated region of presence.

The systems and methods described above also provide for a device locating system comprising a plurality of sensor devices positioned equidistant from one another, each of the plurality of sensor devices including an associated local gateway in communication with a central gateway, a database including previously-recorded received signal strength indication (RSSI) values previously identified by the plurality of sensor devices for a plurality of test devices positioned at different radial distances from the plurality of sensor devices, a processor, and a storage device storing instructions executable to determine an estimated location of a scanned device based on a received signal strength indication (RSSI) value for the scanned device identified by at least three of the plurality of sensor devices and processed in view of the previously-recorded RSSI values identified by the plurality of sensor devices, and output the estimated location of the scanned device to a computing device for controlling operation of the computing device. A first example of the device locating system may additionally or alternatively include the system wherein the instructions are further executable to determining distance values for the scanned device based on the projection of the processed RSSI value on one or more reference curves for that sensor device, determining an estimated region of presence of the scanned device based on the distance values determined by each of the plurality of sensor devices, and determining the estimated location of the scanned device as corresponding to a calculated centroid of the estimated region of presence, the estimated location being projected onto a floor map corresponding to an environment of the scanned devices.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the sensor devices and/or computing device of FIGS. 1 and 2, sensor devices 1, 2, and 3 of FIGS. 6-19, and/or the centralized gateway of FIG. 10. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A device locating system comprising:
three or more sensor devices;
a processor; and
a storage device storing instructions executable to:
determine an estimated location of a scanned device based on a received signal strength indication (RSSI) value for the scanned device measured by at least three of the three or more sensor devices and processed in view of previously-recorded RSSI values for the scanned device and/or instantaneous RSSI values of the scanned device; and
output the estimated location of the scanned device to a computing device for controlling operation of the computing device.

2. The device locating system of claim 1, wherein the scanned device is a wireless-enabled device, and the previously-recorded RSSI values for the scanned device comprise previously-recorded RSSI values for a selected wireless interface type of the scanned device.

3. The device locating system of claim 2, wherein the selected wireless interface type is one of a WI-FI interface and a BLUETOOTH interface.

4. The device locating system of claim 2, wherein the instructions are further executable by the processor to determine a range of distance values for the scanned device by projecting the processed RSSI value onto a reference curve corresponding to the previously-recorded RSSI values for the scanned device.

5. The device locating system of claim 4, wherein the scanned device is a first scanned device, and wherein the reference curve further corresponds to previously-recorded RSSI values for additional scanned devices having the same interface type and device type as the first scanned device.

6. The device locating system of claim 5, wherein the reference curve is generated based on one or more of a piecewise-linear approach and a linear regression approach to determine upper and lower reference relationships between RSSI measurements and radial distances.

7. The device locating system of claim 4, wherein the instructions are further executable by the processor to obtain a set of distance range values corresponding to scanned devices scanned by each of the three or more sensor devices.

8. The device locating system of claim 7, wherein the three or more sensor devices each include a respective local gateway device, and the device locating system further comprising a central gateway device in communication with each of the respective local gateway devices.

9. The device locating system of claim 8, wherein the instructions comprise first instructions, and wherein the central gateway device comprises a gateway processor and a gateway storage device storing second instructions executable by the gateway processor to perform a statistical positioning determination (SPD) from the set of distance range values.

10. The device locating system of claim 9, wherein one or more of the first instructions and the second instructions are further executable to determine points of intersection between selected scanning regions of each of the three or more sensor devices, the selected scanning regions indicating regions at which the scanned device is expected to be present.

11. The device locating system of claim 10, wherein one or more of the first instructions and the second instructions are further executable to determine an order of occurrence of the points of intersection to generate an estimated region of presence of the scanned device.

12. The device locating system of claim 11, wherein one or more of the first instructions and the second instructions are further executable to determine a centroid of the estimated region of presence of the scanned device, the estimated location of the scanned device corresponding to the centroid of the region of presence of the scanned device.

13. A method of estimating a location of a scanned device that is scanned by a sensor device, the method comprising:
identifying, at the sensor device, a received signal strength indication (RSSI) value associated with the scanned device;
estimating, with the sensor device, a location of the scanned device based on the identified RSSI and one or more previously-identified RSSI values; and
outputting the estimated location of the scanned device to a computing device for controlling operation of the computing device.

14. The method of claim 13, further comprising processing the identified RSSI value for the scanned device in view of the one or more previously-identified RSSI values.

15. The method of claim 14, further comprising projecting the processed RSSI value on one or more reference curves, the reference curves being generated based on relationship data previously obtained by the sensor device, and the relationship data indicating a relationship between the one or more previously-identified RSSI values and associated radial distances between the sensor device and one or more test devices previously scanned by the sensor device.

16. The method of claim 15, further comprising, for each of a plurality of sensor devices, determining distance values for the scanned device based on the projection of the processed RSSI value on one or more reference curves for that sensor device.

17. The method of claim 16, further comprising determining an estimated region of presence of the scanned device based on the distance values determined by each of the plurality of sensor devices.

18. The method of claim 17, further comprising computing a centroid of the estimated region of presence of the scanned device and determining the estimated location of the scanned device as corresponding to the centroid of the estimated region of presence.

19. A device locating system comprising:
a plurality of sensor devices positioned equidistant from one another, each of the plurality of sensor devices including an associated local gateway in communication with a central gateway;
a database including previously-recorded received signal strength indication (RSSI) values previously identified by the plurality of sensor devices for a plurality of test devices positioned at different radial distances from the plurality of sensor devices;
a processor; and
a storage device storing instructions executable to:
determine an estimated location of a scanned device based on a received signal strength indication (RSSI) value for the scanned device identified by at least three of the plurality of sensor devices and processed in view of the previously-recorded RSSI values identified by the plurality of sensor devices; and
output the estimated location of the scanned device to a computing device for controlling operation of the computing device.

20. The device locating system of claim 19, wherein the instructions are further executable to determining distance values for the scanned device based on the projection of the processed RSSI value on one or more reference curves for that sensor device, determining an estimated region of presence of the scanned device based on the distance values determined by each of the plurality of sensor devices, and determining the estimated location of the scanned device as corresponding to a calculated centroid of the estimated region of presence, the estimated location being projected onto a floor map corresponding to an environment of the scanned devices.
